(19) United States
(12) Patent Application Publication
(10) Pub. No.: US 2012/0232856 A1
(43) Pub. Date: Sep. 13, 2012

(54) METHOD OF CALCULATING AREAS

(76) Inventor: Claus Bendtsen, Pomezia (IT)

(21) Appl. No.: 13/497,144

(22) PCT Filed: Sep. 21, 2010
(86) PCT No.: PCT/EP2010/063864

§ 371 Date: May 31, 2012

(30) Foreign Application Priority Data
Sep. 23, 2009 (GB) 0916646.3

(51) Int. Cl. G06F 19/16

(52) U.S. Cl. 703/1

(57) ABSTRACT

The present invention relates to a method of determining surface area of a molecule which can be used to calculate to solvent accessible surface areas of molecules, particularly biological molecules such as proteins and identifying potential linear and conformational epitopes of antigens.

The present invention relates to a method of determining surface area of a molecule. This method can be used to calculate the solvent accessible surface area of molecules, particularly biological molecules such as proteins. In turn this method can then be used to identify potential epitopes, both linear and conformational epitopes, of antigens.

An antibody epitope, i.e. a B-cell epitope, is part of an antigen recognised by either a particular antibody molecule or a particular B-cell receptor of the immune system. For a protein antigen, an epitope may either be a short peptide from the protein sequence, called a linear (or continuous) epitope, or a patch of atoms on the protein surface, called a conformational (or discontinuous) epitope. In general, linear epitopes can be directly used for the design of vaccines and immunodiagnostics. In general, conformational epitopes can be used to design molecules that can mimic the structure and immunogenic properties of an epitope and replace it, either in the process of antibody production, so that the epitope mimic can be used as a prophylactic or therapeutic vaccine, or for antibody detection in medical diagnostics or experimental research.

The problem of identifying epitopes, such as B-cell epitopes, on the surface of antigens, is a long-standing challenge in the field of biological mathematics. Various methods have been tried, both in prospect and retrospect, and a brief summary is given by Blythe and Flower, Protein Science (2005), 14:246-248 which concludes that the best available methods are only marginally better than random.

Batori et al, J. Mol. Recognit. (2006), 19:21-29 provides a method using an epitope mapping tool (EMT) using an algorithm. The aim was to find epitopes having as high a relative surface accessibility (RSA) as possible. Residues in a protein having an RSA above a certain value and which correspond to the first residue of known motifs for antibody binding sequences, are taken. The procedure is repeated for the second residue of these motifs, and for all residues in the motif. Epitopes having the same residue more than once, or where the distance between any two residues exceeds 25 Å, are discarded. Epitopes are then ranked according to total relative solvent accessible surface area. This broadly equates to starting with residues in order of decreasing RSA and determining whether they form the beginning of a known epitope motif having at least five residues in common with a database of antibody binding motifs from human, rabbit, rat and mouse IgG and IgE binding sequences in the public domain. In one comparative test, under defined conditions, the method showed 74% predictive efficacy.

An alternative method for predicting conformational epitopes is disclosed in Kulkarni-Kale, Nuc. Acids. Res., 2005, 33, web server issue. Starting from a Protein Data Base (PDB) file the percentage accessibility of residues is calculated using Voronoi polyhedra. Antigenic residues are identified as those having greater than 25% accessible surface area. Antigenic determinants are delineated if at least three contiguous accessible residues are present and these determinants are extended at both termini until one inaccessible residue is included. Conformational epitopes are predicted by collapsing determinants within 6 Å of each other. Sequential epitopes not part of any conformational epitope are identified. Individual accessible accessible residues which form part of identified epitopes are included and determinants and epitopes are listed before defining subsets to represent them graphically. The algorithm was found to have 75% accuracy.

The use of Voronoi and Voronoi-related tessellations applied to protein structures is reviewed in A. Poupon, Cur. Op. Struct. Biol., 2004, 14:223-241. They are applied to the computation of atom and residue volumes, modelling of protein packing, computation of empirical potentials, the study of voids and cavities and molecular dynamics, amongst other applications. One important and relevant feature of these tessellations is that they define the neighbours of each point, in a set of centroid points, unambiguously and without a distance cutoff.

Samanta et al, Protein Engineering, 15(8), 659-667, 2002, describes the accessible surface area (ASA) of residues in a protein in terms of the number of partner atoms in contact (within a distance of 4.5 Å). As this number increases ASA decreases exponentially. For a given number of partner atoms a comparison of the observed ASA with the predicted value is a measure of the goodness of packing of the residue in a protein structure or its importance in the binding of a ligand. The ASA of a protein molecule can be estimated, along with the relative accessibility of different residues which is inversely correlated with hydrophobicity. The standard algorithm used for calculating the average ASA of a residue X is taken as its value in an Ala-X-Ala or Gly-X-Gly sequence in an extended conformation.

Ponomarenko et al, BMC Bioinformatics, 9, 514, 2008, describes a method of predicting B-cell epitopes from 3D protein models. Three algorithms are used. First the surface of the centre of mass of each protein is approximated as an ellipsoid containing a set percentage, such as 90%, of the protein atoms. Next a protrusion index (PI) is defined as the percentage of the protein atoms enclosed in the ellipsoid at which the residue first becomes lying outside the ellipsoid. Third, an algorithm for clustering residues defines a discontinuous epitope based on threshold values for the PI and the distance R between the centre of mass of each residue.

Sweredoski and Baldi, Bioinformatics Applications Note, 24(12), 1459-1460, 2008, describes a method of identifying B-cell epitopes which incorporates an amino-acid propensity scale along with side chain orientation and solvent accessibility information using half sphere exposure values at multiple distance thresholds from the target residue.

In contrast to prior art methods, the present invention provides a method of calculating the surface area of molecules which leads to the identification of potential B-cell epitopes with higher accuracy. The epitopes may be linear or conformational.

Thus the present invention provides a method of determining a surface area of a molecule which comprises
a. taking a structural model of a molecule;
b. identifying and calculating the area of non-connected surface patches on each atom;
c. forming a primary graph having a vertex for each surface patch and an edge between vertices of intersecting surface patches;
d. forming a secondary graph having a vertex for each atom of the molecule and an edge between intersecting atoms;
e. splitting the primary graph into sets of components, each set corresponding to the surface patches on the atoms represented by a component of the secondary graph;
f. identifying the component representing the largest surface area in each set of components to form an atom level graph;
g. calculating the surface area by summing the surface areas represented by the atom level graph.

The structural model is typically a PDB file. Each atom is generally treated as a sphere having its centre at the x, y, z coordinates of the PDB file.

In an embodiment all atoms are treated as spheres in space. By tessellating each atom using spherical triangles and computing intersections between these triangles with neighbouring atoms, the surface of each atom can be represented as a set of non-connected surface patches. Thus each atom may be represented as an octahedron or icosehedron. An exemplary method of performing such calculations using spherical triangles is described in Szalay et al, Technical Report MSR-TR-2005-123, Microsoft Research. The areas of the surface patches can be calculated using spherical trigonometry.

The surface area calculated is preferably the solvent accessible surface area. Generally this is achieved by assuming the atoms in the molecule have probe-extended Van der Waals' radii where the probe size is 1.4 Å.

The molecule is preferably a polypeptide.

When calculating the area using spherical triangles, any spherical triangle or atom falling completely within the radius of another atom is eliminated from the set of spherical triangles. Any spherical triangle falling partially within the radius of another atom is split into two spherical triangles and either of these spherical triangles falling completely within the radius of the other atom is then eliminated from the set of spherical triangles. If either of the spherical triangles still falls partially within the radius of the other atom it is split again and the elimination/splitting step is repeated until no spherical triangles above a predetermined area fall partially within the radius of the other atom. The radius is generally the probe extended Van der Waal's radius where the probe size is usually set at 1.4 Å. The predetermined area may be 0.0004πr² where r is the radius of the atoms.

In the above method, each non-connected subgraph of the secondary graph represents a set of atoms which interact. The number of atom sets defines the number of non-intersecting external surfaces.

Each largest connected subgraph identified from the primary graph corresponds to the external surface of an atom set. The process of calculating the surface area by summing the areas of the largest connected subgraphs eliminates internal surfaces (i.e. cavities) of the molecule.

In determining potential antigens it is of particular interest to calculate the solvent accessible surface areas of a linear n-mer in a polypeptide. The linear n-mer can be a potential linear epitope. Thus the present invention also provides a method of calculating the surface area of a linear n-mer in a polypeptide which comprises:
a. identifying the atom level graph as described above;
b. forming an induced subgraph of the atom level graph with vertices corresponding to the surface patches of atoms in the epitope;
c. summing the surface areas represented by the component of the induced subgraph which represents the largest surface area.

Since there is generally more interest in working at the amino acid level, the invention also provides a method of calculating the surface area of a linear n-mer in a polypeptide which comprises:
a. forming an atom level graph as described above;
b. splitting the atom level graph into induced subgraphs, each corresponding to a residue of the polypeptide;
c. for each component of the induced subgraphs, collapsing the corresponding vertices of the atom level graph to a single vertex to form a residue level graph;
d. forming an induced subgraph of the residue level graph with vertices corresponding to the surface patches of the residues in the epitope;
e. summing the surface areas represented by the component of the induced subgraph which represents the largest surface area.

The process is illustrated in the flow chart of FIG. 1.

Generally each chain in the amino acid sequence of a protein is partitioned into overlapping n-mers, where n is the number of amino acids in the peptide fragment. Typically n ranges from 8 to 36 residues, particularly 10 to 30 residues, more particularly 12 to 25 residues, especially 16 to 22 residues. Thus a set of all possible peptide fragments of a given length is formed. For each n-mer the atom level or residue level graph can be used to calculate the surface area. The method may be applied to all n-mers in a polypeptide. An n-mer is a consecutive series of n amino acids of a polypeptide. In one embodiment n-mers containing cysteines are not included in the set. In another embodiment n-mers containing known glycosylation sites are not included in the set.

It can also be important to calculate the surface area of foreign atoms in a linear n-mer, for instance where the n-mer is a potential linear epitope, which are not part of the linear fragment but which contribute to binding to the antibody. Thus there is also provided a method of calculating the surface area of foreign atoms within a linear n-mer in a polypeptide which comprises:
a. forming an atom level graph as described above;
b. forming a residual atom graph for each component of the atom level graph by deleting vertices corresponding to the atoms of the epitope;
c. removing the component representing the largest surface area from each residual atom graph; and
d. summing the surface areas represented by the remaining vertices in the residual atom graphs.

Since the method can be performed at the residue level as well as the atom level there is also provided a method of calculating the surface area of foreign residues within a linear n-mer of a polypeptide which comprises:
a. forming a residue level graph as described above;
b. forming a residual residue graph for each component of the residue level graph by deleting vertices corresponding to the residues of the epitope;
c. removing the component representing the largest surface area from each residual residue graph; and
d. summing the surface areas represented by the remaining vertices in the residual residue graphs.

If only one surface area is identified in the residual graphs then there are no foreign atoms in the component concerned.

It is generally the case that more compact n-mers are more likely to have potential for hosting an antigenic epitope. Compactness can be calculated where the surface area of a linear n-mer has been calculated using an atom level graph, as described above, by dividing that surface area of the epitope by the square of the largest intra-atomic distance of atoms represented by vertices of the component of the induced subgraph which represents the largest surface area of that epitope.

At residue level compactness can be calculated by dividing the surface area of a linear n-mer of a polypeptide, which has been calculated using a residue level graph as described above, by the square of the largest intra-atomic distance of atoms represented by the vertices of the component of the induced subgraph which represents the largest surface area of that epitope. A linear n-mer can be considered as potentially hosting an epitope when, for a probe size of 1.4 Å, it has a solvent accessible surface area of at least 500 Å², a solvent accessible surface area of foreign atoms or residues of below 10 Å² and a compactness of at least 0.55. Preferably the n-mer has a solvent accessible surface area of at least 900 Å² or a least 1000 Å², no foreign atoms or residues and a compactness of at least 0.65.

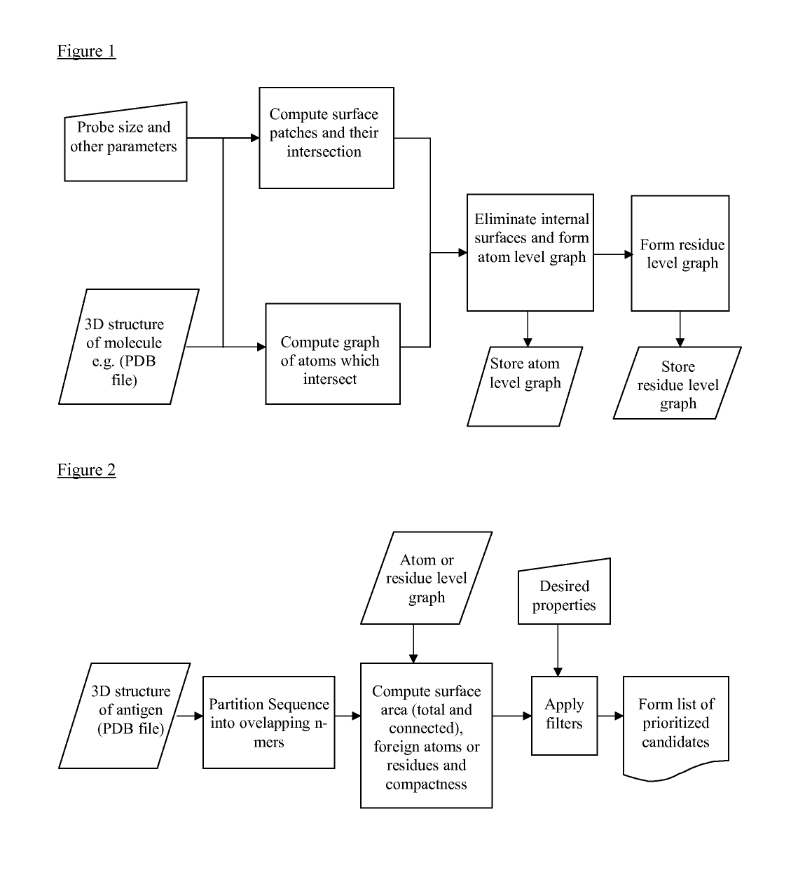

The process is illustrated in the flow chart of FIG. 2.

The present invention can also be used to identify conformational epitopes by a method which comprises:
a. taking each vertex in an atom or residue level graph as defined above, which is based on a structural model of a polypeptide, and adding to it the closest vertex in the graph;
b. repeating step a. by taking the next closest vertex to the original vertex, wherein the next closest vertex has an edge to the original vertex, or to any vertices added to it, until the combined solvent accessible surface area of the vertices reaches a pre-defined area.

Where the atoms in the structural model of the polypeptide have probe extended Van der Waals' radii of 1.4 Å, the predefined solvent accessible surface area is conveniently set at 1000 Å² when using the residue level graph or 900 Å² when using the atom level graph. Once all vertices have been processed to form a set of atom or residue sets representing all potential conformational epitopes, the likely contribution of any atom or residue to the binding affinity of an antibody to an epitope can be approximated to the relative contribution of the atom or residue to the total surface area of the epitope.

The suggested size minima for conformational epitopes is based on computation of the surface of interactions between protein antigens and antibodies for 19 complexes from the PDB.

Alternative size minima when using the residue level graph are 800 Å², 900 Å², 1100 Å², 1200 Å², 1300 Å² and 1400 Å². Alternative size minima when using the atom level graph are 800 Å², 1000 Å², 1100 Å² and 1200 Å².

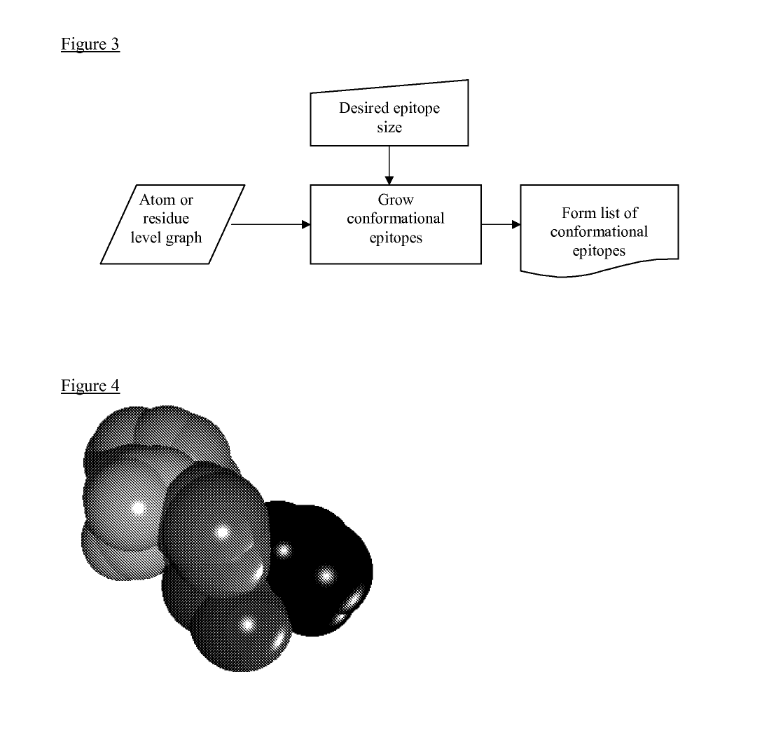

The process of growing conformational epitopes is illustrated in the flow chart of FIG. 3.

The invention described herein can be implemented in computer hardware or software, or a combination of both. Generally speaking, various embodiments of the epitope identification algorithm described herein can be achieved using a computer program providing instructions in a computer readable form. For example, the invention can be implemented by one or more computer programs executing on one or more programmable computers, each containing a processor and at least one input device. The computers will preferably also contain a data storage system (including volatile and non-volatile memory and/or storage elements) and at least one output device.

Program code is applied to input data to perform the functions described above and generate output information. The output information is applied to one or more output devices in a known fashion. The computer can be, for example, a personal computer, microcomputer, or work station of conventional design. One of skill in the art will readily recognize that different types of computer language can be used to provide instructions in a computer readable format. For example, a suitable computer program can be written in languages such as Matlab, S+, C/C++, FORTRAN, PERL, HTML, JAVA, UNIX, or LINUX shell command languages such as C shell script, and different dialects of such languages. Each program is preferably implemented in a high level procedural or object oriented programming language to communicate with a computer system. However, the programs can be implemented in assembly or machine language, if desired. In any case, the language can be a compiled or interpreted language.

Each computer program is preferably stored on a storage media or device (e.g., ROM or magnetic diskette) readable by a general or special purpose programmable computer. The computer program serves to configure and operate the computer to perform the procedures described herein when the program is read by the computer. The method of the invention can also be implemented by means of a computer-readable storage medium, configured with a computer program, where the storage medium so configured causes a computer to operate in a specific and predefined manner to perform the functions described herein.

Different types of computers can be used to run a program implementing the algorithm described herein. For example, computer programs for predicting B-cell epitopes using the disclosed algorithm can be run on a computer having sufficient memory and processing capability. An example of a suitable computer is one having an Intel Pentium®-based processor of 200 MHZ or greater, with 64 MB of main memory. Equivalent and superior computer systems are well known in the art.

Standard operating systems can be employed for different types of computers. Examples of operating systems for an Intel Pentium®-based processor include the Microsoft Windows™ family, such as Windows 7, Windows Vista, Windows NT, Windows XP, Windows 2000 and LINUX. Examples of operating systems for a Macintosh computer include OSX, UNIX and LINUX operating systems. Other computers and operating systems are well known in the art. The data presented herein illustrating various aspects of the invention was producing using software written in the JAVA programming language on a 1.66 GHz, Intel-based computer with 2 GB ram, running Windows XP operating system.

The resulting data can be presented in a variety of formats. The method can involve the additional step of outputting to a monitor, printer, or another output device. For example, data can be presented in a list, a table or a graphic format. In one embodiment, the data can be presented as a list of candidate epitopes ranked in order of their surface area. In an alternative embodiment, data can be presented by underlying, or emphasizing by other means, epitopes within the protein that is shown on the screen or printed out to a printer.

The following Examples illustrate the present invention.

### EXAMPLE 1

### Generating the Surface Graphs

As an example of how to generate the atom and residue level graphs we chose the 5 N-terminal residues of PCSK9 from the PDB structure 2QTW. Using a probe size of 1.4 Åwe assigned the probe extended van der Waals (VdW) radii to each atom as shown in Table 1 and generated the surface shown in FIG. 4.

Each atom was considered as a sphere with the assigned radii, centered at the x,y,z-coordinates from Table 1. Each sphere was then tessellated using spherical triangles as follows:
1. Each sphere was initially represented as an octahedron (i.e. split into 8 spherical triangles). This formed the initial set of spherical triangles representing the sphere.
2. Any spherical triangle on the sphere falling completely within the probe extended VdW radius of another atom was eliminated for the set of spherical triangles.
3. Any spherical triangle falling partially within the probe extended VdW radius of another atom was split into two spherical triangles.
4. This process was repeated until no spherical triangles above a predefined area threshold fell partially within the probe extended VdW radius of another atom. In the Example below the threshold was taken as 0.0004πr2 where r was the probe extended VdW radius.

A spherical triangle graph was formed by creating a vertex for each spherical triangle and an edge between vertices corresponding to intersecting spherical triangles. This graph we reduced to a primary graph by collapsing all vertices which are connected and correspond to a single atom. Thus the primary graph will have no vertices for an atom which has no spherical triangles, 1 vertex for an atom which has spherical triangles forming a single continuous surface patch and k vertices for atoms having k distinct continuous surface patches. The solvent accessible surface area for each surface patch was calculated as the sum of areas of the spherical triangles which tessellate it.

Since the primary graph created may have vertices which correspond to internal cavities these were removed as follows. First a secondary graph was formed having a vertex for each atom and an edge between intersecting atoms. The primary graph was split into sets of components, each set corresponding to the surface patches on the atoms represented by a component of the secondary graph. If the structure for example contained two molecules which were not interacting (as is frequently observed in crystal structures containing multiple copies of the same molecule) we would have two sets of components. We formed the atom level graph as the component for each set of components which corresponded to the largest surface area (calculated as the sum of solvent accessible surface area for each of the surface patches represented by it). Thus we eliminated vertices from the primary graph which represent internal cavities.

Applying this process to the structure in Table 1 results in the atom level graph represented in Table 2.

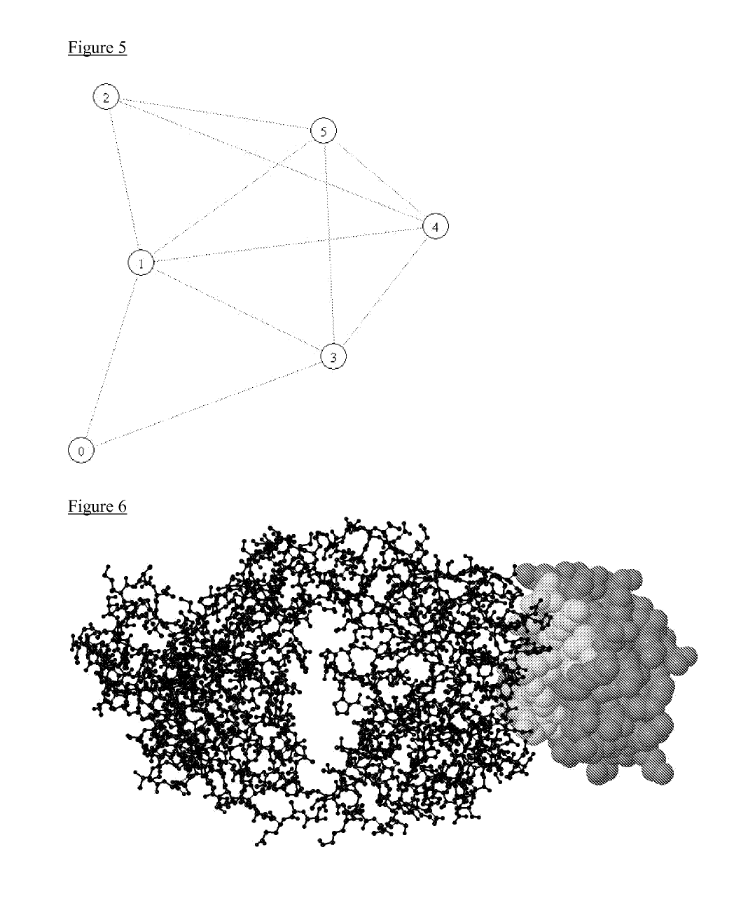

Next we proceeded to create the residue level graph by splitting the atom level graph into induced subgraphs, each corresponded to a residue of the structure, and for each component of the induced subgraphs collapse the corresponding vertices of the atom level graph to a single vertex. This had the effect of representing continuous surface patches corresponding to a single residue by one vertex. Applying this process to the atom level graph from Table 2 produced the residue level graph in Table 3 which is shown graphically in FIG. 5. We noticed that residue 155 was represented by two vertices in the residue level graph which was due to the fact that the solvent accessible surface of the residue was represented by two distinct (non-intersecting) surface patches on the molecule.

TABLE 1
The N-terminal part of structure 2QTW with
assigned VdW radii in Å.

| | Atom | Residue | Residue | | | | VdW + |
|---|---|---|---|---|---|---|---|
| Serial # | Name | Name | # | X | Y | Z | 1.4 Å |
| 750 | N | SER | 153 | 7.673 | 18.19 | 4.782 | 3.025 |
| 751 | CA | SER | 153 | 7.078 | 17.7 | 6.059 | 3.3 |
| 752 | C | SER | 153 | 8.149 | 17.414 | 7.135 | 3.275 |
| 753 | O | SER | 153 | 7.861 | 17.594 | 8.328 | 2.88 |
| 754 | CB | SER | 153 | 6.277 | 16.431 | 5.823 | 3.352 |
| 755 | OG | SER | 153 | 7.147 | 15.41 | 5.346 | 2.935 |
| 756 | N | ILE | 154 | 9.354 | 16.97 | 6.732 | 3.025 |
| 757 | CA | ILE | 154 | 10.462 | 16.783 | 7.698 | 3.3 |
| 758 | C | ILE | 154 | 10.702 | 18.149 | 8.358 | 3.275 |
| 759 | O | ILE | 154 | 10.896 | 19.139 | 7.663 | 2.88 |
| 760 | CB | ILE | 154 | 11.788 | 16.304 | 7.042 | 3.325 |
| 761 | CG1 | ILE | 154 | 11.64 | 14.943 | 6.332 | 3.352 |
| 762 | CG2 | ILE | 154 | 12.936 | 16.185 | 8.095 | 3.355 |
| 763 | CD1 | ILE | 154 | 11.326 | 13.75 | 7.234 | 3.352 |
| 764 | N | PRO | 155 | 10.673 | 18.225 | 9.696 | 3.025 |
| 765 | CA | PRO | 155 | 11.083 | 19.474 | 10.331 | 3.3 |
| 766 | C | PRO | 155 | 12.418 | 19.969 | 9.805 | 3.275 |
| 767 | O | PRO | 155 | 13.303 | 19.178 | 9.594 | 2.88 |
| 768 | CB | PRO | 155 | 11.209 | 19.078 | 11.785 | 3.352 |
| 769 | CG | PRO | 155 | 10.209 | 18.015 | 11.986 | 3.352 |
| 770 | CD | PRO | 155 | 10.281 | 17.214 | 10.694 | 3.3 |
| 771 | N | TRP | 156 | 12.553 | 21.269 | 9.59 | 3.025 |
| 772 | CA | TRP | 156 | 13.726 | 21.87 | 8.948 | 3.3 |
| 773 | C | TRP | 156 | 15.043 | 21.486 | 9.624 | 3.275 |
| 774 | O | TRP | 156 | 16.058 | 21.343 | 8.987 | 2.88 |
| 775 | CB | TRP | 156 | 13.585 | 23.412 | 8.946 | 3.352 |
| 776 | CG | TRP | 156 | 13.974 | 24.13 | 10.261 | 3.275 |
| 777 | CD1 | TRP | 156 | 13.143 | 24.546 | 11.246 | 3.275 |
| 778 | CD2 | TRP | 156 | 15.298 | 24.523 | 10.664 | 3.275 |
| 779 | NE1 | TRP | 156 | 13.855 | 25.134 | 12.265 | 3.025 |
| 780 | CE2 | TRP | 156 | 15.186 | 25.149 | 11.919 | 3.275 |
| 781 | CE3 | TRP | 156 | 16.56 | 24.388 | 10.091 | 3.275 |
| 782 | CZ2 | TRP | 156 | 16.288 | 25.619 | 12.607 | 3.275 |
| 783 | CZ3 | TRP | 156 | 17.646 | 24.888 | 10.759 | 3.275 |
| 784 | CH2 | TRP | 156 | 17.504 | 25.502 | 12.003 | 3.275 |
| 785 | N | ASN | 157 | 14.987 | 21.414 | 10.945 | 3.025 |
| 786 | CA | ASN | 157 | 16.135 | 21.14 | 11.791 | 3.3 |
| 787 | C | ASN | 157 | 16.649 | 19.756 | 11.62 | 3.275 |
| 788 | O | ASN | 157 | 17.862 | 19.521 | 11.648 | 2.88 |
| 789 | CB | ASN | 157 | 15.782 | 21.398 | 13.254 | 3.352 |
| 790 | CG | ASN | 157 | 14.537 | 20.732 | 13.69 | 3.275 |
| 791 | OD1 | ASN | 157 | 13.459 | 21.086 | 13.241 | 2.88 |
| 792 | ND2 | ASN | 157 | 14.644 | 19.813 | 14.642 | 3.025 |

TABLE 2
Vertices in the atom level graph generated from the structure in Table 1.
The Atom ID corresponds to the atom of the surface patch that a
given vertex represents and the SASA contains the corresponding
solvent accessible surface area of that surface patch in Å².
For each vertex the neighbors (i.e. vertices which are connected to
the given vertex by an edge) are listed.

| Vertex | Atom | | |
|---|---|---|---|
| ID | Serial # | SASA | Vertex ID of neighbors |
| 0 | 750 | 43.97 | 1, 3, 5, 6, 7, 10, 11, 12 |
| 1 | 751 | 17.23 | 0, 3, 4, 5, 10 |
| 2 | 752 | 1.32 | 4, 5, 6, 8, 14, 20 |
| 3 | 752 | 1.39 | 0, 1, 4, 9, 10, 15 |
| 4 | 753 | 20.10 | 1, 2, 3, 5, 8, 9, 10, 15, 19, 20 |
| 5 | 754 | 50.06 | 0, 1, 2, 4, 6, 14 |
| 6 | 755 | 29.25 | 0, 2, 5, 7, 8, 12, 14 |
| 7 | 756 | 0.71 | 0, 6, 10, 11, 12 |
| 8 | 757 | 0.42 | 2, 4, 6, 14, 20 |
| 9 | 758 | 0.09 | 3, 4, 10, 15 |
| 10 | 759 | 16.79 | 0, 1, 3, 4, 7, 9, 11, 13, 15, 16, 21, 22, 25 |
| 11 | 760 | 9.70 | 0, 7, 10, 12, 13, 16, 22 |
| 12 | 761 | 31.39 | 0, 6, 7, 11, 13, 14 |
| 13 | 762 | 39.60 | 10, 11, 12, 14, 16, 17, 18, 20, 22, 23, 24, 36 |
| 14 | 763 | 61.17 | 2, 5, 6, 8, 12, 13, 20 |
| 15 | 765 | 10.63 | 3, 4, 9, 10, 18, 19, 21, 27, 41 |
| 16 | 767 | 1.47 | 10, 11, 13, 22, 23, 24, 36 |
| 17 | 767 | 0.65 | 13, 18, 20, 36 |
| 18 | 768 | 14.79 | 13, 15, 17, 19, 20, 21, 27, 36, 39, 40, 41, 42 |
| 19 | 769 | 46.37 | 4, 15, 18, 20, 42 |
| 20 | 770 | 19.30 | 2, 4, 8, 13, 14, 17, 18, 19 |
| 21 | 771 | 3.67 | 10, 15, 18, 22, 25, 27, 41 |
| 22 | 772 | 10.75 | 10, 11, 13, 16, 21, 23, 24, 25, 31 |
| 23 | 773 | 0.11 | 13, 16, 22, 24, 36 |
| 24 | 774 | 24.05 | 13, 16, 22, 23, 25, 31, 33, 35, 36, 37 |
| 25 | 775 | 34.37 | 10, 21, 22, 24, 26, 27, 28, 31 |
| 26 | 776 | 2.23 | 25, 27, 28, 30, 31 |
| 27 | 777 | 30.95 | 15, 18, 21, 25, 26, 28, 29, 30, 41 |
| 28 | 778 | 2.84 | 25, 26, 27, 30, 31, 32, 33, 34 |
| 29 | 779 | 20.36 | 27, 30, 32, 38, 39, 41 |
| 30 | 780 | 4.33 | 26, 27, 28, 29, 31, 32, 33, 34 |
| 31 | 781 | 15.72 | 22, 24, 25, 26, 28, 30, 32, 33, 34, 35, 37 |
| 32 | 782 | 31.83 | 28, 29, 30, 31, 33, 34, 38, 39 |
| 33 | 783 | 33.78 | 24, 28, 30, 31, 32, 34, 35, 37, 38 |
| 34 | 784 | 35.00 | 28, 30, 31, 32, 33, 35, 38 |
| 35 | 786 | 0.98 | 24, 31, 33, 34, 37, 38 |
| 36 | 787 | 19.22 | 13, 16, 17, 18, 23, 24, 37, 38, 40, 42 |
| 37 | 788 | 41.88 | 24, 31, 33, 35, 36, 38, 42 |
| 38 | 789 | 20.05 | 29, 32, 33, 34, 35, 36, 37, 39, 42 |
| 39 | 790 | 6.38 | 18, 29, 32, 38, 41, 42 |
| 40 | 790 | 0.01 | 18, 36, 42 |
| 41 | 791 | 8.56 | 15, 18, 21, 27, 29, 39, 42 |
| 42 | 792 | 46.28 | 18, 19, 36, 37, 38, 39, 40, 41 |

TABLE 3
Vertices in the residue level graph.

| Vertex ID | Residue # | Atom Serial #s | SASA | Neighbor VIDs |
|---|---|---|---|---|
| 0 | 153 | 751, 754, 753, 750, | 163.32 | 1, 3 |
| | | 752, 755 | | |
| 1 | 154 | 758, 757, 756, 762, | 159.87 | 0, 2, 3, 4, 5 |
| | | 759, 763, 761, 760 | | |
| 2 | 155 | 767, 766 | 1.47 | 1, 4, 5 |
| 3 | 155 | 769, 770, 768, 765, | 91.74 | 0, 1, 4, 5 |
| | | 767 | | |
| 4 | 156 | 778, 780, 777, 779, | 249.98 | 1, 2, 3, 5 |
| | | 771, 781, 783, 773, | | |
| | | 784, 775, 774, 776, | | |
| | | 782, 772 | | |
| 5 | 157 | 790, 787, 791, 786, | 143.35 | 1, 2, 3, 4 |
| | | 792, 789, 788 | | |

### EXAMPLE 2

### Generating Linear Epitopes

As a model structure for predicting linear epitopes we used the PDB structure 2P4E which contained a crystal structure of PCSK9. The residue level graph, shown in Table 4, was generated following the same process as in Example 1 and contained 571 vertices.

The structure did not contain the following residues: 1-60, 169-175, 213-218, 450-452, 573-584, 660-667, 683-692. Additionally residue 533 was a known glycosylation site.

In our attempt to identify linear epitopes we considered all possible 16-22 mers which could be generated from the sequence. However, we imposed an initial restriction by only considering n-mers which were available on the structure and which contained neither cysteines nor the known glycosylation site at residue 533. This initial restriction left us with 255 16-mers, 241 17-mers, 229 18-mers, 219 19-mers, 210 20-mers, 202 21-mers, and, 194 22-mers.

We next proceeded to eliminate all n-mers which did not fulfill the following criteria:
1. A connected solvent accessible surface area of at least 900 Å².
2. Absence of foreign atoms/residues internal to the n-mer.
3. A compactness measure of at least 0.65.

Evaluation of the above criteria for a given n-mer was carried out in the following manner:
1. A subgraph G of the residue level graph was induced by taking all the vertices corresponding to the residues in the n-mer from the residue level graph, produced as described above.
2. For each component, Gᵢ of G:
   1. The solvent accessible surface areas corresponding to the vertices in Gᵢ were summed to provide the connected solvent accessible surface area for the i^{th} component of the n-mer.
   2. A subgraph was induced from the residue level graph by taking all vertices which were not in Gᵢ. If this graph was not connected then the i^{th} component of the n-mer contained internal foreign atoms/residues.
   3. The maximal interatomic distance for the atoms corresponding to the vertices in Gᵢ was calculated. Compactness was measured as the solvent accessible surface area of the i^{th} component of the n-mer divided by the square of the maximal interatomic distance.
3. If one of the components of G fulfilled the above criteria then the criteria were considered fulfilled for the n-mer.

After these further restrictions we were left with 57 16-mers, 17-mers and 18-mers, 57 19-mers, 58 20-mers, 63 21-mers, and, 66 22-mers. These fell into 7 distinct regions on the structure which could thus be considered as containing linear epitopes of length 16-22 amino acids and which could easily be used as immunogens.

To evaluate if the identified potential linear epitopes when administered as immunogens would raise antibodies which are cross reactive with PCSK9 we selected 4 n-mers from 4 different regions (shown in bold-face on Table 5). Additionally we chose a 5^{th} n-mer which failed the criterion on solvent accessible surface area. The five selected immunogens are shown in Table 6.

The peptides were synthesized linked to a cysteine using a 4,7,10-trioxa-1,13-tridecanediamine succinimic acid (Ttds) spacer and conjugated to KLH. A total of 10 rabbits, two for each immunogen, were each injected with 250 μg of the KLH conjugated peptide, with a 100 μg boost of the KLH conjugated peptide at days 13, 26 and 41. At day 51 rabbits were bled and the bleed was analyzed by ELISA. 9 rabbits showed anti-peptide titers in excess of 10⁵, while one rabbit immunized with immunogen 1 had a titer of 47,400. This confirms that all peptides were highly immunogenic. Cross reactivity to recombinant hPCSK9 was assessed by plating 500 ng of recombinant hPCSK9 and incubating with 24,300 fold dilution of sera from day 51 and 100 fold dilution of the pre-bleed sera. After 4 fold washing the plate was incubated with anti-rabbit mAb-HRP (Horseradish peroxidase) and after wash developed with 3,3′,5,5′-tetramethylbenzidine (TMB) for 30 minutes and stopped with H₂SO₄. Optical densities were read on a Multiskan Ascent at 450 nm with subtraction of the O.D.s read at 620 nm to improve sensitivity. Table 7 shows the O.D.s from which is it clear that immunogens 1, 2 and 3 elicited highly cross reactive antibodies to the full length protein. Immunogen 5 which failed the criterion showed little cross reactivity and immunogen 4 showed no cross reactivity.

Thus the overall success rate for identifying linear epitopes was 75%, which indicated that the process described herein is able to identify linear epitopes efficiently.

TABLE 4
The residue level graph generated from 2P4E.

| Vertex ID | Residue # | Atom Serial #s | SASA | Neighbor VIDs |
|---|---|---|---|---|
| 0 | 153 | 745, 744, 743, 748, 746, | 166.08 | 1, 2 |
| | | 747 | | |
| 1 | 154 | 756, 755, 752, 753, 750, | 113.66 | 0, 2, 3, 5, 6, 10 |
| | | 751, 749, 754 | | |
| 2 | 155 | 758, 763, 761, 762 | 30.08 | 0, 1, 3, 4, 5, 71, 72, 166 |
| 3 | 156 | 764, 769, 767, 765, 775, | 47.82 | 1, 2, 4, 6, 7, 148, 164, 165 |
| | | 770, 773, 772, 768 | | |
| 4 | 157 | 784 | 0.28 | 2, 3, 165, 166 |
| 5 | 158 | 793, 787, 792, 790, 789, | 17.55 | 1, 2, 6, 8, 10, 71, 73, 74, 75, 241 |
| | | 788 | | |
| 6 | 159 | 801, 798, 797, 799, 796, | 90.46 | 1, 3, 5, 7, 9, 10, 16 |
| | | 802, 795, 800 | | |
| 7 | 160 | 805, 804, 810, 806, 812, | 74.54 | 3, 6, 9, 148, 149, 150, 212, 237, |
| | | 803, 809, 807, 808, 813 | | 238, 239 |
| 8 | 161 | 819, 821 | 3.00 | 5, 10, 74, 241 |
| 9 | 162 | 828, 825, 826 | 15.36 | 6, 7, 12, 13, 14, 16, 239 |
| 10 | 162 | 827, 828 | 18.27 | 1, 5, 6, 8, 11, 16, 241 |
| 11 | 163 | 834, 835 | 2.45 | 10, 16, 241, 242, 243, 245 |
| 12 | 163 | 833, 830 | 1.44 | 9, 14, 239, 240, 244 |
| 13 | 163 | 831, 832 | 3.75 | 9, 14, 16 |
| 14 | 164 | 841, 838, 837, 840, 842, | 145.68 | 9, 12, 13, 15, 16, 239, 240, 244 |
| | | 839 | | |
| 15 | 165 | 849, 844, 843, 848, 847, | 157.38 | 14, 16, 17, 244, 245, 246 |
| | | 850, 853, 852 | | |
| 16 | 166 | 865, 861, 862, 855, 854, | 137.13 | 6, 9, 10, 11, 13, 14, 15, 17, 18, 19, |
| | | 857, 864, 858, 863, 860, | | 242, 243, 245 |
| | | 856 | | |
| 17 | 167 | 873, 866, 869, 872, 871, | 206.92 | 15, 16, 19, 245 |
| | | 867, 876, 868, 875, 870 | | |
| 18 | 167 | 868 | 0.00 | 16, 19 |
| 19 | 168 | 879, 878, 877, 880, 881 | 157.14 | 16, 17, 18 |
| 20 | 176 | 884, 883, 885, 882 | 39.94 | 21, 74, 75, 76, 183, 187 |
| 21 | 178 | 893, 890, 892, 895, 894, | 100.82 | 20, 22, 23, 76, 77, 78, 187 |
| | | 891 | | |
| 22 | 179 | 897, 896, 898, 901, 900, | 89.97 | 21, 23, 24, 108, 109, 110, 111, 187, |
| | | 902, 899, 903 | | 190 |
| 23 | 180 | 907, 906 | 0.14 | 21, 22, 24, 78 |
| 24 | 181 | 917, 919, 915, 911, 916 | 19.02 | 22, 23, 78, 79, 80, 108, 109, 111 |
| 25 | 181 | 918 | 0.77 | 26, 80, 108 |
| 26 | 183 | 937, 938, 936, 935 | 8.66 | 25, 47, 80, 97, 98, 101, 103, 108, |
| | | | | 112 |
| 27 | 187 | 966 | 0.64 | 29, 30, 81, 82, 83 |
| 28 | 187 | 969 | 3.01 | 63, 66, 67, 86, 89, 568 |
| 29 | 188 | 971, 974, 975 | 32.51 | 27, 30, 51, 64, 65, 83, 86 |
| 30 | 189 | 981, 976, 979, 982 | 18.31 | 27, 29, 31, 32, 46, 65, 81 |
| 31 | 190 | 986, 990, 992, 989, 985, | 43.60 | 30, 32, 33, 59, 60, 65, 170, 171, |
| | | 991 | | 172, 173 |
| 32 | 191 | 995, 998, 993, 997, 996 | 32.47 | 30, 31, 33, 41, 42, 44, 45, 46 |
| 33 | 192 | 1002, 1000, 1004, 1006, | 106.47 | 31, 32, 35, 41, 173 |
| | | 1005, 1003, 999, 1001 | | |
| 34 | 193 | 1015 | 0.51 | 35, 37, 174, 176 |
| 35 | 194 | 1024, 1023, 1027, 1021, | 125.20 | 33, 34, 37, 41, 70, 173, 174 |
| | | 1026, 1022, 1020, 1019 | | |
| 36 | 194 | 1020 | 0.00 | 38, 40, 41, 70 |
| 37 | 195 | 1035, 1033, 1029, 1028 | 2.22 | 34, 35, 70, 71, 176 |
| 38 | 195 | 1031, 1030 | 0.03 | 36, 40, 41, 43, 70 |
| 39 | 195 | 1031 | 0.10 | 43, 69, 70 |
| 40 | 196 | 1038, 1039 | 0.13 | 36, 38, 41, 43, 70 |
| 41 | 197 | 1051, 1052, 1046, 1048, | 72.46 | 32, 33, 35, 36, 38, 40, 42, 43, 70 |
| | | 1053, 1050, 1049 | | |
| 42 | 198 | 1054, 1055, 1057, 1056 | 61.63 | 32, 41, 43, 44 |
| 43 | 199 | 1064, 1060, 1059, 1067, | 130.36 | 38, 39, 40, 41, 42, 44, 45, 69, 70, |
| | | 1063, 1061, 1068, 1065 | | 75, 76, 78, 79 |
| 44 | 200 | 1072, 1071 | 12.53 | 32, 42, 43, 45, 46 |
| 45 | 201 | 1083, 1076, 1082, 1080, | 92.89 | 32, 43, 44, 46, 47, 79, 80 |
| | | 1081, 1077 | | |
| 46 | 202 | 1088, 1090, 1084, 1089, | 58.02 | 30, 32, 44, 45, 47, 48, 81 |
| | | 1087 | | |
| 47 | 203 | 1097, 1093, 1094, 1092, | 29.18 | 26, 45, 46, 48, 49, 80, 97 |
| | | 1095 | | |
| 48 | 204 | 1103, 1105, 1100, 1099, | 115.59 | 46, 47, 49, 50, 51, 81, 82, 83, 97 |
| | | 1102, 1101, 1098, 1104 | | |
| 49 | 205 | 1107, 1112, 1106, 1114, | 25.67 | 47, 48, 51, 52, 95, 97 |
| | | 1110 | | |
| 50 | 205 | 1109 | 0.91 | 48, 51, 81, 82, 83 |
| 51 | 206 | 1123, 1122, 1117, 1119, | 96.28 | 29, 48, 49, 50, 52, 53, 83 |
| | | 1121, 1125, 1124, 1120 | | |
| 52 | 207 | 1130, 1133, 1128, 1132, | 47.44 | 49, 51, 53, 92, 94, 95, 539 |
| | | 1129, 1131, 1127 | | |
| 53 | 208 | 1134, 1137, 1135, 1140, | 46.59 | 51, 52, 54, 55, 56, 83, 84, 92 |
| | | 1136 | | |
| 54 | 209 | 1142, 1146, 1143, 1144, | 31.60 | 53, 55, 56, 84, 85, 90, 91, 92, 93, |
| | | 1145 | | 495 |
| 55 | 210 | 1150, 1149, 1151, 1154, | 164.00 | 53, 54, 56, 57, 85, 88, 90 |
| | | 1156, 1155, 1153, 1152, | | |
| | | 1148 | | |
| 56 | 211 | 1163, 1165, 1164, 1157, | 85.26 | 53, 54, 55, 57, 83, 84, 86, 87 |
| | | 1161, 1162, 1160, 1159 | | |
| 57 | 212 | 1167, 1166, 1172, 1169, | 143.96 | 55, 56, 85, 87, 88, 90 |
| | | 1168, 1171, 1170, 1173 | | |
| 58 | 219 | 1179, 1174, 1178, 1180, | 181.52 | 59, 60, 61, 62, 64, 86 |
| | | 1177, 1175, 1181, 1182, | | |
| | | 1176 | | |
| 59 | 220 | 1183, 1187, 1185, 1184 | 75.23 | 31, 58, 60, 64, 65 |
| 60 | 221 | 1193, 1189, 1188, 1192, | 53.93 | 31, 58, 59, 61, 65, 66, 169, 170, |
| | | 1190, 1191 | | 171 |
| 61 | 222 | 1194, 1200, 1202, 1199, | 167.38 | 58, 60, 62, 63, 66, 67, 86 |
| | | 1197, 1201, 1198 | | |
| 62 | 223 | 1208, 1203, 1204 | 0.28 | 58, 61, 86 |
| 63 | 223 | 1206 | 0.68 | 28, 61, 66, 67, 86 |
| 64 | 223 | 1208, 1207 | 9.58 | 29, 58, 59, 65, 83, 86 |
| 65 | 224 | 1214, 1216, 1215 | 15.26 | 29, 30, 31, 59, 60, 64 |
| 66 | 225 | 1221, 1220, 1222, 1218, | 33.02 | 28, 60, 61, 63, 67, 68, 167, 168, |
| | | 1217 | | 169, 177, 179, 180 |
| 67 | 226 | 1224, 1227, 1223, 1230 | 24.45 | 28, 61, 63, 66, 89, 179, 182, 568, |
| | | | | 570 |
| 68 | 229 | 1248 | 0.00 | 66, 167, 168, 177, 180 |
| 69 | 235 | 1288 | 0.33 | 39, 43, 70, 75 |
| 70 | 237 | 1297, 1295, 1305, 1301, | 146.44 | 35, 36, 37, 38, 39, 40, 41, 43, 69, |
| | | 1299, 1298, 1296, 1304, | | 71, 75 |
| | | 1302, 1300 | | |
| 71 | 238 | 1307, 1311, 1312, 1310, | 101.86 | 2, 5, 37, 70, 72, 75, 176 |
| | | 1309, 1313, 1308 | | |
| 72 | 239 | 1318 | 4.11 | 2, 71, 166, 176 |
| 73 | 240 | 1322 | 1.58 | 5, 74, 75 |
| 74 | 241 | 1326, 1324 | 11.11 | 5, 8, 20, 73, 75, 183, 241 |
| 75 | 243 | 1342, 1335, 1338, 1337, | 97.43 | 5, 20, 43, 69, 70, 71, 73, 74, 76, |
| | | 1343, 1339, 1340, 1341 | | 183 |
| 76 | 244 | 1345, 1344, 1346, 1347 | 38.16 | 20, 21, 43, 75, 77, 78 |
| 77 | 245 | 1349, 1350 | 0.22 | 21, 76, 78 |
| 78 | 246 | 1357, 1358, 1353 | 45.04 | 21, 23, 24, 43, 76, 77, 79, 80 |
| 79 | 247 | 1361, 1362, 1359 | 1.90 | 24, 43, 45, 78, 80 |
| 80 | 248 | 1373, 1372, 1374, 1377, | 57.94 | 24, 25, 26, 45, 47, 78, 79, 101, 108 |
| | | 1376 | | |
| 81 | 249 | 1382, 1381, 1383, 1380 | 3.88 | 27, 30, 46, 48, 50, 82, 83 |
| 82 | 250 | 1385, 1387, 1386 | 1.33 | 27, 48, 50, 81, 83 |
| 83 | 251 | 1399, 1398, 1396, 1401, | 34.26 | 27, 29, 48, 50, 51, 53, 56, 64, 81, |
| | | 1393, 1392, 1402 | | 82, 84, 86 |
| 84 | 254 | 1422 | 0.01 | 53, 54, 56, 83 |
| 85 | 254 | 1425 | 0.23 | 54, 55, 57, 88, 90 |
| 86 | 255 | 1430, 1431, 1429, 1428 | 34.45 | 28, 29, 56, 58, 61, 62, 63, 64, 83, |
| | | | | 87, 89 |
| 87 | 256 | 1433, 1439, 1435, 1438, | 102.30 | 56, 57, 86, 89, 90, 567, 568 |
| | | 1436, 1434, 1440, 1437 | | |
| 88 | 256 | 1440 | 0.02 | 55, 57, 85, 90 |
| 89 | 257 | 1442, 1443, 1441, 1444 | 7.70 | 28, 67, 86, 87, 90, 567, 568 |
| 90 | 258 | 1451, 1450, 1453, 1452 | 48.12 | 54, 55, 57, 85, 87, 88, 89, 91, 495, |
| | | | | 565, 566, 567 |
| 91 | 259 | 1457 | 0.20 | 54, 90, 93, 495, 565 |
| 92 | 260 | 1464, 1463 | 12.27 | 52, 53, 54, 94, 495, 563 |
| 93 | 260 | 1464 | 0.11 | 54, 91, 495, 565 |
| 94 | 262 | 1477, 1474, 1476 | 5.69 | 52, 92, 95, 498, 539, 563 |
| 95 | 266 | 1504, 1500, 1503 | 17.27 | 49, 52, 94, 96, 97, 530, 531, 539 |
| 96 | 269 | 1521, 1522, 1519, 1524 | 1.84 | 95, 97, 100, 531 |
| 97 | 270 | 1527, 1532, 1530, 1529, | 68.58 | 26, 47, 48, 49, 95, 96, 100, 101 |
| | | 1535, 1526, 1534, 1536 | | |
| 98 | 271 | 1540 | 0.01 | 26, 103, 112 |
| 99 | 272 | 1555, 1552, 1554, 1550 | 37.05 | 102, 104, 122, 125, 534 |
| 100 | 273 | 1562, 1558, 1564, 1557, | 66.21 | 96, 97, 101, 104, 105, 531, 532, |
| | | 1560, 1563, 1559, 1561 | | 533, 534 |
| 101 | 274 | 1565, 1569, 1570, 1568, | 32.13 | 26, 80, 97, 100, 103, 105, 106 |
| | | 1567, 1566 | | |
| 102 | 275 | 1577, 1574, 1579, 1576, | 32.45 | 99, 104, 107, 108, 109, 113, 125, |
| | | 1573, 1575 | | 126, 127 |
| 103 | 275 | 1576, 1572, 1571, 1575 | 2.39 | 26, 98, 101, 106, 108, 112 |
| 104 | 276 | 1584, 1583, 1586, 1582, | 108.46 | 99, 100, 102, 105, 107, 534 |
| | | 1587, 1581 | | |
| 105 | 277 | 1593, 1594, 1589, 1591, | 107.89 | 100, 101, 104, 106, 107 |
| | | 1592, 1590 | | |
| 106 | 278 | 1602, 1597, 1599, 1601, | 134.65 | 101, 103, 105, 107, 108 |
| | | 1598, 1596, 1600, 1603 | | |
| 107 | 279 | 1607, 1605, 1610, 1608, | 106.05 | 102, 104, 105, 106, 108 |
| | | 1609, 1606 | | |
| 108 | 280 | 1617, 1613, 1616, 1615, | 80.98 | 22, 24, 25, 26, 80, 102, 103, 106, |
| | | 1611, 1614, 1612 | | 107, 109, 111, 112 |
| 109 | 281 | 1621, 1619, 1620, 1618 | 32.55 | 22, 24, 102, 108, 110, 111, 113 |
| 110 | 282 | 1626, 1623, 1628, 1627, | 27.43 | 22, 109, 113, 126, 129, 186, 190 |
| | | 1622 | | |
| 111 | 282 | 1625 | 0.02 | 22, 24, 108, 109 |
| 112 | 283 | 1636, 1635 | 0.74 | 26, 98, 103, 108 |
| 113 | 283 | 1632, 1633, 1629 | 2.63 | 102, 109, 110, 126, 127, 129, 186 |
| 114 | 292 | 1693, 1694 | 0.26 | 116, 117, 485, 564 |
| 115 | 292 | 1693, 1692 | 1.24 | 116, 485, 488 |
| 116 | 293 | 1705, 1703, 1699, 1700, | 130.70 | 114, 115, 117, 118, 119, 135, 136, |
| | | 1702, 1704, 1695, 1698, | | 139, 484, 485, 488, 560 |
| | | 1701, 1706 | | |
| 117 | 294 | 1708, 1711 | 0.64 | 114, 116, 118, 560, 564 |
| 118 | 295 | 1720, 1714, 1719, 1716, | 88.20 | 116, 117, 119, 120, 481, 483, 558, |
| | | 1722, 1723, 1718, 1717, | | 559, 560 |
| | | 1713 | | |
| 119 | 298 | 1745, 1743, 1741 | 6.71 | 116, 118, 120, 121, 139, 141 |
| 120 | 299 | 1750, 1748, 1751, 1747 | 24.88 | 118, 119, 121, 122, 141, 536, 559 |
| 121 | 302 | 1768, 1771, 1769, 1767, | 59.30 | 119, 120, 122, 124, 141, 142 |
| | | 1770 | | |
| 122 | 303 | 1779, 1782, 1773, 1776, | 93.72 | 99, 120, 121, 124, 125, 503, 534, |
| | | 1781, 1772, 1778 | | 535, 536 |
| 123 | 305 | 1794, 1793 | 7.03 | 124, 126, 128, 142, 197 |
| 124 | 306 | 1806, 1800, 1797, 1802, | 178.51 | 121, 122, 123, 125, 126, 142, 281 |
| | | 1803, 1799, 1801, 1798, | | |
| | | 1805 | | |
| 125 | 307 | 1811, 1810, 1808, 1809 | 29.40 | 99, 102, 122, 124, 126 |
| 126 | 308 | 1815, 1812, 1814, 1813 | 58.89 | 102, 110, 113, 123, 124, 125, 127, |
| | | | | 128, 129, 197 |
| 127 | 309 | 1822, 1817 | 0.26 | 102, 113, 126 |
| 128 | 309 | 1819, 1818 | 0.01 | 123, 126, 129, 197 |
| 129 | 310 | 1829 | 6.20 | 110, 113, 126, 128, 185, 186, 193, |
| | | | | 194, 195, 196, 197, 200 |
| 130 | 317 | 1869, 1873, 1870 | 26.51 | 131, 155, 158, 181, 568, 569, 570 |
| 131 | 318 | 1878, 1884, 1877, 1882, | 40.12 | 130, 132, 133, 137, 158, 491, 567, |
| | | 1880, 1879 | | 569 |
| 132 | 319 | 1891, 1888, 1889, 1895, | 87.64 | 131, 133, 154, 157, 158, 159, 220, |
| | | 1892, 1894, 1890 | | 223 |
| 133 | 320 | 1897, 1901, 1900, 1903, | 41.29 | 131, 132, 134, 136, 137, 159, 488 |
| | | 1902 | | |
| 134 | 321 | 1911, 1904, 1908, 1910 | 26.34 | 133, 135, 136, 159, 160, 226, 227, |
| | | | | 231 |
| 135 | 323 | 1921, 1922, 1919, 1920 | 19.98 | 116, 134, 136, 139, 160, 161 |
| 136 | 324 | 1926, 1930, 1924, 1929, | 86.19 | 116, 133, 134, 135, 488 |
| | | 1927 | | |
| 137 | 325 | 1939, 1942 | 4.79 | 131, 133, 488, 491 |
| 138 | 328 | 1959 | 0.71 | 139, 140, 143, 144, 161 |
| 139 | 329 | 1965, 1964, 1963 | 17.57 | 116, 119, 135, 138, 140, 141, 161 |
| 140 | 330 | 1969, 1970 | 7.00 | 138, 139, 141, 142, 143, 144 |
| 141 | 331 | 1973, 1976, 1978, 1977 | 59.87 | 119, 120, 121, 139, 140, 142 |
| 142 | 332 | 1987, 1985, 1979, 1984, | 50.15 | 121, 123, 124, 140, 141, 143, 197, |
| | | 1980, 1986 | | 201, 202, 278, 280, 281 |
| 143 | 333 | 1991, 1994 | 6.27 | 138, 140, 142, 144, 163, 202 |
| 144 | 335 | 2008 | 0.93 | 138, 140, 143, 161, 163 |
| 145 | 340 | 2038, 2040 | 18.81 | 149, 151, 152, 154, 164 |
| 146 | 340 | 2037 | 0.00 | 148, 164 |
| 147 | 340 | 2037 | 0.04 | 148, 149, 164 |
| 148 | 341 | 2045, 2044, 2041 | 38.07 | 3, 7, 146, 147, 149, 150, 164 |
| 149 | 342 | 2052, 2047, 2054, 2053, | 129.32 | 7, 145, 147, 148, 150, 151, 164, |
| | | 2051, 2048, 2050, 2049 | | 215 |
| 150 | 343 | 2059, 2061, 2062 | 20.78 | 7, 148, 149, 151, 212, 215, 237 |
| 151 | 344 | 2070, 2069, 2067, 2071, | 45.68 | 145, 149, 150, 152, 215, 217, 220 |
| | | 2068 | | |
| 152 | 345 | 2075 | 2.63 | 145, 151, 154, 220 |
| 153 | 346 | 2084 | 0.05 | 154, 155, 164, 181 |
| 154 | 347 | 2090, 2089, 2091, 2086, | 71.81 | 132, 145, 152, 153, 155, 156, 157, |
| | | 2092, 2088 | | 164, 181, 220 |
| 155 | 348 | 2100, 2097, 2094, 2096, | 42.77 | 130, 153, 154, 156, 157, 158, 164, |
| | | 2099, 2095 | | 181 |
| 156 | 349 | 2103, 2104, 2102, 2101 | 70.96 | 154, 155, 157 |
| 157 | 350 | 2105, 2108, 2109, 2107, | 133.97 | 132, 154, 155, 156, 158 |
| | | 2110, 2111, 2106 | | |
| 158 | 351 | 2116, 2118, 2112, 2117, | 80.38 | 130, 131, 132, 155, 157 |
| | | 2119 | | |
| 159 | 355 | 2147, 2148, 2149 | 5.29 | 132, 133, 134, 223, 227 |
| 160 | 357 | 2161, 2156, 2157, 2154, | 83.44 | 134, 135, 161, 162, 163, 226, 230, |
| | | 2159, 2155, 2164, 2158, | | 231, 234, 259, 260, 261, 262, 327 |
| | | 2163, 2160 | | |
| 161 | 358 | 2166, 2170, 2167, 2168, | 21.01 | 135, 138, 139, 144, 160, 162, 163 |
| | | 2169 | | |
| 162 | 359 | 2174, 2173 | 3.33 | 160, 161, 163, 234 |
| 163 | 360 | 2182, 2184, 2185, 2183, | 30.18 | 143, 144, 160, 161, 162, 202, 203, |
| | | 2179, 2181 | | 207, 234, 236, 255 |
| 164 | 366 | 2229, 2226, 2228, 2227, | 55.64 | 3, 145, 146, 147, 148, 149, 153, |
| | | 2225, 2224 | | 154, 155, 165, 181 |
| 165 | 367 | 2237, 2230, 2233, 2231, | 79.16 | 3, 4, 164, 166, 178, 179, 181 |
| | | 2236, 2234, 2235 | | |
| 166 | 369 | 2253, 2250, 2246, 2251, | 53.95 | 2, 4, 72, 165, 176, 177, 178 |
| | | 2252 | | |
| 167 | 371 | 2261 | 0.02 | 66, 68, 168, 169, 177, 180 |
| 168 | 372 | 2264, 2268, 2267 | 11.85 | 66, 68, 167, 169, 171, 175, 176, |
| | | | | 177, 180 |
| 169 | 373 | 2269, 2274 | 2.63 | 60, 66, 167, 168, 171, 177 |
| 170 | 373 | 2272 | 0.08 | 31, 60, 171, 172 |
| 171 | 374 | 2281, 2280, 2276, 2275, | 110.23 | 31, 60, 168, 169, 170, 172, 175 |
| | | 2282, 2279, 2277, 2278 | | |
| 172 | 375 | 2284, 2288, 2287, 2285 | 49.76 | 31, 170, 171, 173, 174, 175 |
| 173 | 376 | 2294, 2293, 2289 | 53.01 | 31, 33, 35, 172, 174 |
| 174 | 377 | 2300, 2295, 2301, 2296, | 89.09 | 34, 35, 172, 173, 175, 176 |
| | | 2299, 2298, 2297 | | |
| 175 | 378 | 2303, 2306, 2307 | 39.24 | 168, 171, 172, 174, 176 |
| 176 | 379 | 2314, 2313, 2315, 2308, | 85.27 | 34, 37, 71, 72, 166, 168, 174, 175, |
| | | 2316, 2317, 2312, 2318, | | 177 |
| | | 2311, 2310 | | |
| 177 | 380 | 2324, 2325, 2323, 2320 | 56.84 | 66, 68, 166, 167, 168, 169, 176, |
| | | | | 178, 179, 180 |
| 178 | 381 | 2328, 2326, 2331, 2329, | 49.80 | 165, 166, 177, 179, 181 |
| | | 2330 | | |
| 179 | 382 | 2334, 2337, 2336, 2333, | 35.74 | 66, 67, 165, 177, 178, 181, 182 |
| | | 2340, 2339, 2338 | | |
| 180 | 382 | 2340 | 0.03 | 66, 68, 167, 168, 177 |
| 181 | 383 | 2346, 2345, 2341, 2344 | 45.78 | 130, 153, 154, 155, 164, 165, 178, |
| | | | | 179, 182, 570 |
| 182 | 387 | 2371, 2370, 2372 | 0.96 | 67, 179, 181, 570 |
| 183 | 398 | 2436, 2435, 2438, 2439, | 58.65 | 20, 74, 75, 184, 187, 188, 241, 242 |
| | | 2434, 2433 | | |
| 184 | 399 | 2444, 2445, 2443, 2441, | 5.16 | 183, 188, 189, 205, 210, 242 |
| | | 2447, 2446 | | |
| 185 | 400 | 2455 | 0.02 | 129, 193, 195, 196, 200 |
| 186 | 400 | 2454, 2455 | 2.56 | 110, 113, 129, 190, 194 |
| 187 | 401 | 2461, 2458, 2460, 2459 | 33.62 | 20, 21, 22, 183, 188, 190 |
| 188 | 402 | 2463, 2465, 2464, 2462, | 83.63 | 183, 184, 187, 189, 190, 242 |
| | | 2466 | | |
| 189 | 403 | 2471, 2472, 2473, 2468, | 59.00 | 184, 188, 190, 191, 192, 205, 206, |
| | | 2475, 2474, 2469 | | 247 |
| 190 | 404 | 2480, 2479, 2481, 2482, | 57.69 | 22, 110, 186, 187, 188, 189, 191, |
| | | 2478 | | 194 |
| 191 | 405 | 2491, 2489, 2483, 2488, | 167.19 | 189, 190, 192, 194, 195, 199 |
| | | 2486, 2490, 2487, 2485, | | |
| | | 2484 | | |
| 192 | 406 | 2493, 2499, 2492 | 6.81 | 189, 191, 199, 206 |
| 193 | 406 | 2495 | 0.00 | 129, 185, 196, 200 |
| 194 | 406 | 2495, 2494 | 13.41 | 129, 186, 190, 191, 195, 197 |
| 195 | 407 | 2506, 2502, 2501, 2504 | 63.32 | 129, 185, 191, 194, 197, 198, 199, |
| | | | | 282 |
| 196 | 407 | 2502 | 0.02 | 129, 185, 193, 200 |
| 197 | 408 | 2514, 2507, 2512, 2511 | 22.92 | 123, 126, 128, 129, 142, 194, 195, |
| | | | | 198, 201 |
| 198 | 409 | 2519, 2516, 2515 | 3.82 | 195, 197, 201, 280, 281, 282 |
| 199 | 410 | 2526, 2527, 2528, 2525 | 51.52 | 191, 192, 195, 206, 282, 332 |
| 200 | 411 | 2533, 2536 | 0.00 | 129, 185, 193, 196 |
| 201 | 412 | 2546, 2547 | 0.38 | 142, 197, 198, 280 |
| 202 | 412 | 2546, 2544, 2543, 2547 | 9.15 | 142, 143, 163, 255, 278 |
| 203 | 412 | 2542, 2543 | 0.59 | 163, 207, 255 |
| 204 | 413 | 2551, 2556 | 1.07 | 207, 208, 252, 254 |
| 205 | 414 | 2563, 2561, 2562 | 1.56 | 184, 189, 210, 247 |
| 206 | 414 | 2567, 2566 | 27.19 | 189, 192, 199, 247, 253, 332 |
| 207 | 416 | 2583, 2582, 2581 | 26.08 | 163, 203, 204, 208, 213, 236, 254, |
| | | | | 255, 256, 457 |
| 208 | 417 | 2588, 2593, 2590, 2585, | 69.11 | 204, 207, 209, 211, 213, 247, 249, |
| | | 2591, 2592, 2587 | | 250, 252, 253, 458 |
| 209 | 418 | 2598, 2602, 2600, 2604, | 29.00 | 208, 211, 212, 213, 239, 240, 244, |
| | | 2597, 2596, 2595 | | 247, 253 |
| 210 | 418 | 2603 | 0.91 | 184, 205, 242, 247 |
| 211 | 419 | 2608, 2607 | 7.55 | 208, 209, 212, 213, 239 |
| 212 | 420 | 2611, 2612, 2615 | 40.37 | 7, 150, 209, 211, 213, 215, 237, |
| | | | | 238, 239 |
| 213 | 421 | 2624, 2620, 2616, 2621, | 60.45 | 207, 208, 209, 211, 212, 214, 215, |
| | | 2619, 2623 | | 457 |
| 214 | 422 | 2625, 2629, 2630, 2631, | 115.37 | 213, 215, 216, 235, 457 |
| | | 2632, 2628, 2627 | | |
| 215 | 423 | 2638, 2636, 2634, 2639, | 57.39 | 149, 150, 151, 212, 213, 214, 216, |
| | | 2637, 2635 | | 217, 237 |
| 216 | 424 | 2642, 2643 | 7.25 | 214, 215, 217, 218, 235 |
| 217 | 425 | 2654, 2648, 2655, 2652, | 91.25 | 151, 215, 216, 218, 219, 220 |
| | | 2649, 2653, 2651 | | |
| 218 | 426 | 2660, 2663, 2662, 2661, | 87.94 | 216, 217, 219, 221, 228, 229, 235 |
| | | 2664, 2656 | | |
| 219 | 427 | 2667, 2669, 2665, 2668, | 64.62 | 217, 218, 220, 222, 223, 228 |
| | | 2666 | | |
| 220 | 428 | 2671, 2670, 2674, 2676, | 49.21 | 132, 151, 152, 154, 217, 219, 222, |
| | | 2678, 2672, 2673 | | 223 |
| 221 | 429 | 2693, 2691 | 1.83 | 218, 228, 232, 233, 235 |
| 222 | 429 | 2686, 2687 | 1.87 | 219, 220, 223, 228 |
| 223 | 430 | 2699, 2700, 2696, 2695, | 65.32 | 132, 159, 219, 220, 222, 224, 225, |
| | | 2701 | | 227, 228 |
| 224 | 431 | 2708, 2702, 2707, 2710, | 136.62 | 223, 225, 228, 229 |
| | | 2705, 2709, 2706, 2703, | | |
| | | 2704 | | |
| 225 | 432 | 2712, 2715, 2716, 2714, | 78.94 | 223, 224, 227, 229, 231, 294, 327 |
| | | 2718, 2713, 2711, 2717 | | |
| 226 | 433 | 2726 | 0.09 | 134, 160, 231 |
| 227 | 433 | 2727, 2724, 2725 | 27.17 | 134, 159, 223, 225, 231, 294 |
| 228 | 434 | 2731, 2729, 2732, 2730, | 70.70 | 218, 219, 221, 222, 223, 224, 229, |
| | | 2738, 2737, 2734 | | 232 |
| 229 | 435 | 2739, 2744, 2742, 2745, | 28.90 | 218, 224, 225, 228, 230, 232, 259, |
| | | 2741, 2740 | | 292, 294, 453, 456, 461 |
| 230 | 436 | 2748, 2749 | 5.34 | 160, 229, 232, 234, 259 |
| 231 | 436 | 2752 | 7.58 | 134, 160, 225, 226, 227, 294, 327 |
| 232 | 437 | 2756, 2760, 2757, 2758 | 11.04 | 221, 228, 229, 230, 233, 234, 235 |
| 233 | 438 | 2764, 2763 | 0.01 | 221, 232, 235 |
| 234 | 438 | 2761, 2766, 2767, 2762, | 31.38 | 160, 162, 163, 230, 232, 235, 236 |
| | | 2765 | | |
| 235 | 439 | 2773, 2772, 2770, 2769, | 19.68 | 214, 216, 218, 221, 232, 233, 234, |
| | | 2775, 2771, 2768 | | 236, 456, 457 |
| 236 | 440 | 2781, 2783, 2782 | 7.14 | 163, 207, 234, 235, 457 |
| 237 | 441 | 2788, 2787, 2789 | 0.71 | 7, 150, 212, 215, 238, 239 |
| 238 | 442 | 2794 | 0.51 | 7, 212, 237, 239 |
| 239 | 443 | 2800 | 9.96 | 7, 9, 12, 14, 209, 211, 212, 237, |
| | | | | 238, 240 |
| 240 | 444 | 2804 | 0.58 | 12, 14, 209, 239, 244 |
| 241 | 444 | 2808, 2805, 2807 | 32.39 | 5, 8, 10, 11, 74, 183, 242 |
| 242 | 445 | 2815, 2814, 2812, 2813 | 33.51 | 11, 16, 183, 184, 188, 210, 241, |
| | | | | 243, 245, 247 |
| 243 | 446 | 2819, 2818 | 5.28 | 11, 16, 242, 245, 247 |
| 244 | 446 | 2821, 2820, 2822 | 23.94 | 12, 14, 15, 209, 240, 246, 247 |
| 245 | 447 | 2825, 2823, 2824, 2828, | 49.49 | 11, 15, 16, 17, 242, 243, 246, 247 |
| | | 2827, 2826 | | |
| 246 | 448 | 2834, 2833, 2832, 2830, | 107.45 | 15, 244, 245, 247 |
| | | 2835, 2831 | | |
| 247 | 449 | 2844, 2840, 2839, 2838, | 102.54 | 189, 205, 206, 208, 209, 210, 242, |
| | | 2843, 2837, 2842, 2845 | | 243, 244, 245, 246, 253 |
| 248 | 453 | 2852, 2855, 2856, 2857, | 153.72 | 249, 253, 332, 334, 335, 400, 476 |
| | | 2854, 2848, 2853, 2858, | | |
| | | 2846, 2849, 2851, 2847, | | |
| | | 2850 | | |
| 249 | 454 | 2861, 2865, 2860, 2863, | 69.71 | 208, 248, 250, 251, 252, 253, 332, |
| | | 2867, 2866, 2868, 2864 | | 427, 429, 430, 431, 476 |
| 250 | 455 | 2872 | 1.54 | 208, 249, 252, 254, 430 |
| 251 | 455 | 2873, 2869 | 2.10 | 249, 431, 474, 475, 476 |
| 252 | 456 | 2883, 2881, 2878 | 3.61 | 204, 208, 249, 250, 254, 430 |
| 253 | 456 | 2887, 2884, 2886 | 11.62 | 206, 208, 209, 247, 248, 249, 332 |
| 254 | 457 | 2888, 2891 | 14.23 | 204, 207, 250, 252, 255, 330, 430 |
| 255 | 458 | 2895, 2903, 2900, 2898, | 31.14 | 163, 202, 203, 207, 254, 256, 258, |
| | | 2904 | | 275, 277, 278, 330 |
| 256 | 459 | 2908, 2910, 2909, 2911, | 39.06 | 207, 255, 258, 259, 330, 455, 456, |
| | | 2905 | | 457 |
| 257 | 459 | 2911 | 0.22 | 328, 329, 331, 454 |
| 258 | 460 | 2913, 2917, 2918 | 27.33 | 255, 256, 259, 260, 274, 275 |
| 259 | 461 | 2930, 2919, 2927, 2925, | 24.86 | 160, 229, 230, 256, 258, 260, 453, |
| | | 2922, 2923 | | 455, 456 |
| 260 | 462 | 2937, 2934 | 4.62 | 160, 258, 259, 261, 272, 273, 274 |
| 261 | 463 | 2942, 2940, 2939, 2943, | 54.44 | 160, 260, 262, 263, 272, 273, 327 |
| | | 2941 | | |
| 262 | 464 | 2944, 2951, 2949, 2947, | 72.16 | 160, 261, 263, 264, 265, 272, 293, |
| | | 2950, 2952, 2953, 2948, | | 294, 323, 324, 325, 326, 327 |
| | | 2946 | | |
| 263 | 465 | 2957, 2956, 2955 | 25.39 | 261, 262, 264, 266, 269, 271, 272 |
| 264 | 466 | 2962, 2960, 2961 | 19.51 | 262, 263, 265, 266, 323 |
| 265 | 467 | 2967, 2966, 2968, 2969, | 97.63 | 262, 264, 266, 267, 320, 321, 322, |
| | | 2970 | | 323 |
| 266 | 468 | 2977, 2975, 2972, 2976 | 92.96 | 263, 264, 265, 267, 268, 269 |
| 267 | 469 | 2978, 2983, 2987, 2985, | 160.06 | 265, 266, 268, 299, 318, 320 |
| | | 2988, 2979, 2981, 2980, | | |
| | | 2984, 2982 | | |
| 268 | 470 | 2996, 2990, 2995, 2992, | 168.04 | 266, 267, 269, 270, 271, 317, 318 |
| | | 2993, 2989, 2994, 2991 | | |
| 269 | 471 | 2998, 3001 | 5.25 | 263, 266, 268, 271 |
| 270 | 471 | 3000 | 0.43 | 268, 271, 317, 318 |
| 271 | 472 | 3002, 3007, 3008, 3005 | 53.37 | 263, 268, 269, 270, 272, 273, 316, |
| | | | | 317 |
| 272 | 473 | 3010 | 3.49 | 260, 261, 262, 263, 271, 273 |
| 273 | 474 | 3014, 3021, 3018, 3017, | 45.70 | 260, 261, 271, 272, 274, 275, 309, |
| | | 3019 | | 316 |
| 274 | 475 | 3023 | 1.36 | 258, 260, 273, 275 |
| 275 | 476 | 3031, 3037, 3036, 3029, | 126.79 | 255, 258, 273, 274, 276, 277, 309, |
| | | 3033, 3034, 3032, 3027, | | 312, 314, 315 |
| | | 3030, 3028 | | |
| 276 | 477 | 3038 | 0.20 | 275, 312, 314, 315 |
| 277 | 477 | 3040, 3041 | 12.73 | 255, 275, 278, 279, 281, 312 |
| 278 | 478 | 3044, 3045, 3048 | 6.01 | 142, 202, 255, 277, 281 |
| 279 | 478 | 3046 | 0.01 | 277, 281, 312 |
| 280 | 478 | 3048 | 2.79 | 142, 198, 201, 281, 282 |
| 281 | 479 | 3054, 3052, 3055, 3049, | 115.68 | 124, 142, 198, 277, 278, 279, 280, |
| | | 3053, 3051, 3050 | | 282, 283, 312 |
| 282 | 480 | 3061, 3060, 3063, 3058, | 63.64 | 195, 198, 199, 280, 281, 283, 284, |
| | | 3057, 3056, 3062, 3059 | | 332, 333 |
| 283 | 481 | 3066, 3067 | 1.19 | 281, 282, 284, 312 |
| 284 | 482 | 3077, 3081, 3078, 3080, | 52.75 | 282, 283, 285, 312, 313, 333, 336, |
| | | 3079, 3074 | | 337, 338 |
| 285 | 483 | 3089, 3085, 3082, 3086 | 7.14 | 284, 306, 312, 313, 338, 342, 396 |
| 286 | 485 | 3100, 3103, 3102 | 7.42 | 288, 290, 328, 329, 331, 368, 432, |
| | | | | 433, 434 |
| 287 | 486 | 3107 | 0.21 | 289, 303, 368, 435 |
| 288 | 486 | 3105, 3106, 3107, 3104 | 0.78 | 286, 290, 328, 329, 331, 368, 434 |
| 289 | 487 | 3114, 3111 | 4.64 | 287, 291, 303, 368, 434, 435, 436, |
| | | | | 452 |
| 290 | 487 | 3114, 3115, 3110 | 5.36 | 286, 288, 328, 434, 454 |
| 291 | 488 | 3119, 3116 | 0.68 | 289, 298, 303, 451, 452 |
| 292 | 489 | 3131, 3132 | 2.04 | 229, 294, 449, 461 |
| 293 | 490 | 3138, 3134 | 1.13 | 262, 294, 323, 324, 325, 326 |
| 294 | 491 | 3146, 3145, 3141, 3144, | 69.45 | 225, 227, 229, 231, 262, 292, 293, |
| | | 3143, 3139, 3148, 3140, | | 295, 323, 324, 326, 327, 449, 461, |
| | | 3149, 3142 | | 464 |
| 295 | 492 | 3154, 3150, 3153, 3151 | 22.15 | 294, 296, 297, 323, 450, 464 |
| 296 | 493 | 3159, 3158, 3157 | 24.75 | 295, 297, 298, 445, 448, 450, 464 |
| 297 | 494 | 3165, 3164, 3166, 3168, | 104.75 | 295, 296, 298, 319, 321, 323 |
| | | 3161, 3167 | | |
| 298 | 495 | 3174, 3179, 3176, 3169, | 32.99 | 291, 296, 297, 300, 302, 303, 319, |
| | | 3178, 3172 | | 370, 373, 437, 447, 448, 451, 452 |
| 299 | 496 | 3186, 3187, 3190, 3189, | 50.31 | 267, 317, 318, 320, 371, 375, 376, |
| | | 3184 | | 378 |
| 300 | 496 | 3185 | 0.12 | 298, 319, 373, 378 |
| 301 | 496 | 3187, 3190 | 0.01 | 319, 320, 378 |
| 302 | 497 | 3192 | 0.10 | 298, 303, 370, 373 |
| 303 | 498 | 3201, 3202, 3203 | 13.61 | 287, 289, 291, 298, 302, 368, 369, |
| | | | | 370 |
| 304 | 499 | 3208, 3213, 3210, 3214 | 72.51 | 305, 307, 316, 317, 371, 395 |
| 305 | 500 | 3218 | 5.44 | 304, 307, 313, 341, 344, 395 |
| 306 | 500 | 3221, 3219 | 0.33 | 285, 313, 342, 396 |
| 307 | 501 | 3231, 3227, 3224, 3230, | 44.78 | 304, 305, 308, 309, 313, 316, 341 |
| | | 3229 | | |
| 308 | 502 | 3236, 3235, 3234, 3232 | 72.20 | 307, 309, 310, 311, 312, 313 |
| 309 | 503 | 3239, 3240, 3243, 3244, | 61.65 | 273, 275, 307, 308, 310, 312, 315, |
| | | 3242, 3241, 3245, 3238 | | 316 |
| 310 | 504 | 3249, 3247, 3246, 3248 | 91.98 | 308, 309, 311, 312 |
| 311 | 505 | 3253, 3250, 3252, 3251 | 81.90 | 308, 310, 312, 313 |
| 312 | 506 | 3261, 3256, 3255, 3262, | 57.11 | 275, 276, 277, 279, 281, 283, 284, |
| | | 3258, 3260, 3259 | | 285, 308, 309, 310, 311, 313, 314, |
| | | | | 315 |
| 313 | 507 | 3266, 3263, 3267, 3270, | 39.81 | 284, 285, 305, 306, 307, 308, 311, |
| | | 3268, 3269 | | 312, 338, 339, 340, 341, 342 |
| 314 | 507 | 3266 | 0.11 | 275, 276, 312, 315 |
| 315 | 508 | 3276 | 4.02 | 275, 276, 309, 312, 314 |
| 316 | 510 | 3294, 3293, 3291, 3290 | 37.53 | 271, 273, 304, 307, 309, 317 |
| 317 | 512 | 3304, 3309, 3305, 3301, | 29.30 | 268, 270, 271, 299, 304, 316, 318, |
| | | 3306, 3307, 3308 | | 371, 375 |
| 318 | 513 | 3313, 3310 | 2.54 | 267, 268, 270, 299, 317 |
| 319 | 514 | 3322 | 9.01 | 297, 298, 300, 301, 320, 321, 378 |
| 320 | 515 | 3333, 3327, 3329, 3324, | 130.58 | 265, 267, 299, 301, 319, 321, 322, |
| | | 3323, 3331, 3328, 3326, | | 378 |
| | | 3330, 3332 | | |
| 321 | 516 | 3334, 3336, 3335, 3337 | 56.24 | 265, 297, 319, 320, 322, 323 |
| 322 | 517 | 3340, 3341, 3339 | 8.28 | 265, 320, 321, 323 |
| 323 | 518 | 3343, 3349, 3347, 3348, | 82.32 | 262, 264, 265, 293, 294, 295, 297, |
| | | 3346, 3342, 3350, 3345 | | 321, 322, 324 |
| 324 | 519 | 3354 | 0.69 | 262, 293, 294, 323, 325 |
| 325 | 520 | 3356 | 0.02 | 262, 293, 324, 326 |
| 326 | 521 | 3370, 3368 | 0.39 | 262, 293, 294, 325 |
| 327 | 521 | 3371, 3373 | 12.62 | 160, 225, 231, 261, 262, 294 |
| 328 | 523 | 3385, 3382 | 4.39 | 257, 286, 288, 290, 329, 331, 454 |
| 329 | 524 | 3389, 3390 | 0.71 | 257, 286, 288, 328, 331 |
| 330 | 525 | 3402, 3401 | 4.66 | 254, 255, 256, 430, 457, 458 |
| 331 | 525 | 3397, 3396, 3398, 3392 | 3.27 | 257, 286, 288, 328, 329, 432, 454 |
| 332 | 528 | 3422, 3416, 3419, 3421, | 14.13 | 199, 206, 248, 249, 253, 282, 333, |
| | | 3418, 3417 | | 334 |
| 333 | 529 | 3426, 3425, 3423 | 4.21 | 282, 284, 332, 334, 336 |
| 334 | 530 | 3431, 3433, 3437, 3436, | 104.36 | 248, 332, 333, 335, 336 |
| | | 3434, 3435, 3432 | | |
| 335 | 531 | 3439, 3441, 3444, 3440, | 69.99 | 248, 334, 336, 337, 397, 399, 400, |
| | | 3438, 3445, 3442, 3446, | | 476 |
| | | 3443 | | |
| 336 | 532 | 3449, 3450 | 11.04 | 284, 333, 334, 335, 337, 338 |
| 337 | 533 | 3454, 3457, 3455, 3459, | 103.82 | 284, 335, 336, 338, 340, 365, 397 |
| | | 3453, 3456, 3458 | | |
| 338 | 534 | 3460, 3463, 3462, 3464 | 26.55 | 284, 285, 313, 336, 337, 339, 340, |
| | | | | 396 |
| 339 | 535 | 3469, 3468 | 0.62 | 313, 338, 342, 396 |
| 340 | 535 | 3471, 3470, 3467 | 39.68 | 313, 337, 338, 341, 343, 360, 365 |
| 341 | 536 | 3474, 3475, 3472, 3477, | 38.71 | 305, 307, 313, 340, 343, 344 |
| | | 3476 | | |
| 342 | 536 | 3478 | 1.82 | 285, 306, 313, 339, 396 |
| 343 | 537 | 3486, 3481, 3480, 3483, | 29.61 | 340, 341, 344, 356, 357, 359, 360 |
| | | 3487, 3485, 3484, 3488 | | |
| 344 | 538 | 3493, 3492, 3491, 3494, | 79.43 | 305, 341, 343, 345, 346, 356, 371, |
| | | 3489, 3495 | | 393, 395 |
| 345 | 539 | 3500, 3497 | 18.77 | 344, 346, 354, 355, 356 |
| 346 | 540 | 3506, 3504, 3502, 3507, | 93.90 | 344, 345, 347, 348, 354, 393 |
| | | 3505 | | |
| 347 | 541 | 3511, 3512, 3514, 3510, | 68.66 | 346, 348, 372, 374, 376, 390, 391, |
| | | 3513 | | 393 |
| 348 | 542 | 3517, 3518, 3516, 3519 | 34.09 | 346, 347, 349, 352, 354, 355, 390 |
| 349 | 543 | 3527, 3521, 3524, 3525, | 125.07 | 348, 350, 351, 352, 390 |
| | | 3528, 3522, 3520, 3526 | | |
| 350 | 544 | 3529, 3532, 3531, 3533 | 53.22 | 349, 351, 353, 390 |
| 351 | 545 | 3538, 3537, 3536, 3539, | 122.87 | 349, 350, 352, 353, 390 |
| | | 3534, 3535 | | |
| 352 | 546 | 3544, 3541, 3540, 3545, | 89.67 | 348, 349, 351, 353, 354, 355, 386 |
| | | 3542, 3546, 3543, 3547 | | |
| 353 | 547 | 3549 | 8.12 | 350, 351, 352, 386, 387, 389, 390 |
| 354 | 548 | 3558, 3553 | 0.91 | 345, 346, 348, 352, 355 |
| 355 | 549 | 3565, 3563, 3562, 3569, | 103.61 | 345, 348, 352, 354, 356, 357, 384, |
| | | 3561, 3568, 3559, 3566 | | 386 |
| 356 | 550 | 3571, 3575, 3572, 3574 | 18.13 | 343, 344, 345, 355, 357, 384 |
| 357 | 551 | 3580, 3583, 3586, 3584, | 91.64 | 343, 355, 356, 358, 359, 382, 383, |
| | | 3581, 3577, 3582, 3585 | | 384 |
| 358 | 552 | 3590 | 5.20 | 357, 359, 360, 383 |
| 359 | 553 | 3600, 3599, 3595, 3602, | 131.02 | 343, 357, 358, 360, 361 |
| | | 3598, 3594, 3596, 3601, | | |
| | | 3597 | | |
| 360 | 554 | 3605, 3609, 3606, 3611, | 78.63 | 340, 343, 358, 359, 361, 363, 365, |
| | | 3610, 3607, 3604 | | 383 |
| 361 | 555 | 3619, 3618, 3616, 3612, | 151.18 | 359, 360, 362, 363, 364, 365, 366, |
| | | 3614, 3620, 3613, 3615, | | 383, 397 |
| | | 3617 | | |
| 362 | 556 | 3622, 3624, 3621, 3623 | 16.68 | 361, 366, 397, 398, 399 |
| 363 | 557 | 3628 | 0.04 | 360, 361, 383 |
| 364 | 557 | 3628, 3627 | 1.00 | 361, 366, 383 |
| 365 | 557 | 3632, 3633, 3634 | 16.74 | 337, 340, 360, 361, 397 |
| 366 | 558 | 3639, 3640 | 23.74 | 361, 362, 364, 367, 383, 398, 401, |
| | | | | 402, 403, 477 |
| 367 | 559 | 3649, 3645, 3646, 3642 | 8.43 | 366, 368, 383, 384, 403, 405, 471, |
| | | | | 472 |
| 368 | 562 | 3664, 3666, 3663, 3665, | 25.63 | 286, 287, 288, 289, 303, 367, 369, |
| | | 3661 | | 384, 385, 386, 394, 433, 434, 435, |
| | | | | 436, 471 |
| 369 | 563 | 3670, 3668, 3669 | 3.87 | 303, 368, 370, 394, 436 |
| 370 | 564 | 3678, 3673, 3677, 3676 | 22.18 | 298, 302, 303, 369, 373, 386, 388, |
| | | | | 389, 392, 394 |
| 371 | 565 | 3687, 3686, 3688 | 17.44 | 299, 304, 317, 344, 375, 376, 393, |
| | | | | 395 |
| 372 | 565 | 3687, 3686, 3688, 3682 | 0.03 | 347, 374, 376, 393 |
| 373 | 566 | 3695, 3700, 3702, 3697, | 29.97 | 298, 300, 302, 370, 378, 379, 380, |
| | | 3701, 3699 | | 389, 392 |
| 374 | 566 | 3690 | 1.22 | 347, 372, 376, 391, 393 |
| 375 | 566 | 3692 | 1.63 | 299, 317, 371, 376 |
| 376 | 567 | 3703, 3711, 3704, 3710, | 131.76 | 299, 347, 371, 372, 374, 375, 377, |
| | | 3708, 3705, 3706, 3709, | | 378, 391, 393 |
| | | 3707 | | |
| 377 | 568 | 3717, 3716, 3713, 3718, | 49.41 | 376, 378, 379, 391 |
| | | 3712 | | |
| 378 | 569 | 3719, 3720, 3725, 3721, | 148.11 | 299, 300, 301, 319, 320, 373, 376, |
| | | 3722, 3723, 3727, 3726, | | 377, 379 |
| | | 3724 | | |
| 379 | 570 | 3733, 3729, 3731, 3735, | 106.61 | 373, 377, 378, 380, 381, 391 |
| | | 3730, 3734, 3732 | | |
| 380 | 571 | 3738, 3740, 3739, 3741, | 55.56 | 373, 379, 381, 389, 392, 444 |
| | | 3742, 3736 | | |
| 381 | 572 | 3745, 3744, 3746, 3747 | 84.16 | 379, 380, 389, 390, 391 |
| 382 | 585 | 3752, 3753, 3751, 3748, | 171.25 | 357, 383, 384 |
| | | 3750, 3749, 3754 | | |
| 383 | 586 | 3759, 3760, 3762, 3756, | 53.39 | 357, 358, 360, 361, 363, 364, 366, |
| | | 3755, 3761 | | 367, 382, 384, 405 |
| 384 | 587 | 3767, 3771, 3768, 3766, | 71.22 | 355, 356, 357, 367, 368, 382, 383, |
| | | 3770, 3769, 3763 | | 385, 386 |
| 385 | 588 | 3776, 3773 | 2.10 | 368, 384, 386, 394 |
| 386 | 589 | 3783, 3781, 3784, 3782, | 70.18 | 352, 353, 355, 368, 370, 384, 385, |
| | | 3780, 3778 | | 387, 388, 394, 439, 440 |
| 387 | 590 | 3788, 3787 | 3.62 | 353, 386, 389, 390, 440 |
| 388 | 590 | 3786 | 2.57 | 370, 386, 389, 394, 440 |
| 389 | 591 | 3797, 3790, 3794, 3793, | 48.75 | 353, 370, 373, 380, 381, 387, 388, |
| | | 3789, 3795 | | 390, 392, 440 |
| 390 | 592 | 3809, 3804, 3808, 3805, | 99.64 | 347, 348, 349, 350, 351, 353, 381, |
| | | 3803, 3802, 3806, 3799 | | 387, 389, 391 |
| 391 | 593 | 3818, 3815, 3817, 3813, | 38.26 | 347, 374, 376, 377, 379, 381, 390, |
| | | 3814, 3816, 3811 | | 393 |
| 392 | 594 | 3823 | 0.41 | 370, 373, 380, 389 |
| 393 | 595 | 3828, 3824, 3829 | 9.57 | 344, 346, 347, 371, 372, 374, 376, |
| | | | | 391, 395 |
| 394 | 596 | 3837 | 1.45 | 368, 369, 370, 385, 386, 388 |
| 395 | 597 | 3844, 3846 | 4.54 | 304, 305, 344, 371, 393 |
| 396 | 599 | 3857, 3858 | 1.59 | 285, 306, 338, 339, 342 |
| 397 | 602 | 3879, 3874, 3875, 3880, | 63.87 | 335, 337, 361, 362, 365, 399 |
| | | 3877, 3876 | | |
| 398 | 603 | 3884, 3883 | 0.90 | 362, 366, 399, 401, 477 |
| 399 | 604 | 3889, 3888, 3890, 3892, | 80.91 | 335, 362, 397, 398, 400, 401, 477 |
| | | 3891, 3887 | | |
| 400 | 605 | 3893, 3896, 3894, 3895 | 24.95 | 248, 335, 399, 476, 477 |
| 401 | 606 | 3900 | 1.53 | 366, 398, 399, 402, 477 |
| 402 | 607 | 3912, 3910, 3909, 3911, | 41.19 | 366, 401, 403, 404, 428, 475, 476, |
| | | 3913, 3906 | | 477 |
| 403 | 608 | 3914, 3917, 3916, 3918 | 35.09 | 366, 367, 402, 404, 405, 472 |
| 404 | 609 | 3921, 3925, 3923, 3926, | 127.79 | 402, 403, 405, 406, 428, 472, 473, |
| | | 3928, 3922, 3927, 3924 | | 475 |
| 405 | 610 | 3929, 3931, 3935, 3933, | 93.20 | 367, 383, 403, 404, 406, 407, 470, |
| | | 3932, 3934 | | 471, 472, 473 |
| 406 | 611 | 3942, 3941, 3943, 3944, | 76.21 | 404, 405, 407, 420, 421, 422, 423, |
| | | 3940, 3937 | | 424, 473 |
| 407 | 612 | 3953, 3949, 3952, 3948, | 110.16 | 405, 406, 408, 409, 420, 439, 469, |
| | | 3950, 3945, 3951, 3947 | | 470 |
| 408 | 613 | 3959, 3956, 3955, 3962, | 82.24 | 407, 409, 410, 418, 419, 420, 469 |
| | | 3960, 3961, 3963, 3958 | | |
| 409 | 614 | 3966, 3964, 3967, 3965 | 33.18 | 407, 408, 410, 411, 468, 469 |
| 410 | 615 | 3975, 3974, 3972, 3973 | 59.02 | 408, 409, 411, 414, 417, 418 |
| 411 | 616 | 3981, 3977, 3980, 3982 | 75.09 | 409, 410, 412, 413, 414, 466, 468 |
| 412 | 617 | 3983, 3985, 3986, 3987 | 33.58 | 411, 413, 415, 445, 462, 466, 467 |
| 413 | 618 | 3990, 3994, 3991, 3989, | 125.98 | 411, 412, 414, 415, 416 |
| | | 3992, 3993 | | |
| 414 | 619 | 4003, 4002, 4000, 4001, | 80.90 | 410, 411, 413, 416, 417 |
| | | 3999, 3996 | | |
| 415 | 619 | 3998, 3997 | 1.81 | 412, 413, 416, 445, 462, 464 |
| 416 | 620 | 4009, 4007, 4012, 4010, | 106.04 | 413, 414, 415, 417, 449, 461, 463, |
| | | 4004, 4011, 4005, 4008 | | 464 |
| 417 | 621 | 4017, 4021, 4020, 4019, | 75.81 | 410, 414, 416, 418, 419, 453, 460, |
| | | 4018, 4016, 4013 | | 461 |
| 418 | 622 | 4023, 4027 | 3.70 | 408, 410, 417, 419 |
| 419 | 623 | 4034, 4032, 4033, 4029, | 53.29 | 408, 417, 418, 420, 421, 459, 460 |
| | | 4031, 4035 | | |
| 420 | 624 | 4037, 4038, 4042 | 9.61 | 406, 407, 408, 419, 421, 459 |
| 421 | 625 | 4047, 4043, 4046 | 41.89 | 406, 419, 420, 422, 424, 458, 459 |
| 422 | 626 | 4050, 4051 | 13.10 | 406, 421, 424, 425, 426, 429, 458 |
| 423 | 626 | 4049 | 0.14 | 406, 424, 473 |
| 424 | 627 | 4055, 4062, 4054, 4059, | 98.68 | 406, 421, 422, 423, 426, 428, 473 |
| | | 4061, 4060, 4058 | | |
| 425 | 627 | 4057, 4056 | 1.25 | 422, 426, 427, 429, 458 |
| 426 | 628 | 4067, 4069, 4065, 4070, | 187.17 | 422, 424, 425, 427, 428, 429 |
| | | 4071, 4068, 4064, 4066, | | |
| | | 4063 | | |
| 427 | 629 | 4072, 4075, 4074, 4073 | 57.84 | 249, 425, 426, 428, 429, 430, 431, |
| | | | | 474, 475 |
| 428 | 630 | 4083, 4088, 4087, 4082, | 19.64 | 402, 404, 424, 426, 427, 473, 475 |
| | | 4086, 4084, 4081, 4080, | | |
| | | 4085 | | |
| 429 | 630 | 4079, 4078 | 4.24 | 249, 422, 425, 426, 427, 430, 458 |
| 430 | 631 | 4095, 4096 | 8.30 | 249, 250, 252, 254, 330, 427, 429, |
| | | | | 458 |
| 431 | 631 | 4090, 4095 | 1.00 | 249, 251, 427, 474, 475 |
| 432 | 634 | 4114, 4113 | 0.22 | 286, 331, 434, 454 |
| 433 | 634 | 4114, 4113 | 1.48 | 286, 368, 434, 436, 470, 471 |
| 434 | 635 | 4118, 4119, 4117, 4120, | 6.99 | 286, 288, 289, 290, 368, 432, 433, |
| | | 4116 | | 436, 454, 470, 471 |
| 435 | 635 | 4119 | 0.01 | 287, 289, 368, 436 |
| 436 | 636 | 4127, 4123, 4126 | 26.60 | 289, 368, 369, 433, 434, 435, 437, |
| | | | | 439, 452, 470, 471 |
| 437 | 637 | 4128, 4130, 4132, 4131 | 26.03 | 298, 436, 438, 439, 440, 442, 447, |
| | | | | 448, 451, 452, 470 |
| 438 | 638 | 4136, 4135 | 0.54 | 437, 440, 442, 448 |
| 439 | 638 | 4140, 4137, 4139, 4136, | 78.80 | 386, 407, 436, 437, 440, 441, 443, |
| | | 4134, 4138 | | 469, 470 |
| 440 | 639 | 4147, 4143, 4145, 4144, | 54.89 | 386, 387, 388, 389, 437, 438, 439, |
| | | 4146, 4142 | | 441, 442, 444 |
| 441 | 640 | 4150, 4149, 4148, 4151 | 58.22 | 439, 440, 442, 443, 467, 468 |
| 442 | 641 | 4153, 4154, 4152, 4155, | 22.56 | 437, 438, 440, 441, 444, 448, 467 |
| | | 4156, 4157 | | |
| 443 | 641 | 4157 | 0.28 | 439, 441, 468, 469 |
| 444 | 642 | 4164, 4163, 4162, 4160, | 101.96 | 380, 440, 442, 445, 446, 448, 467 |
| | | 4159, 4161 | | |
| 445 | 643 | 4166, 4172, 4170, 4171, | 47.00 | 296, 412, 415, 444, 448, 450, 462, |
| | | 4174, 4167, 4173, 4169 | | 464, 467 |
| 446 | 643 | 4165 | 0.12 | 444, 448 |
| 447 | 644 | 4180 | 0.22 | 298, 437, 451, 452 |
| 448 | 644 | 4180, 4181, 4178, 4179, | 25.31 | 296, 298, 437, 438, 442, 444, 445, |
| | | 4175, 4177 | | 446, 450 |
| 449 | 645 | 4188 | 8.33 | 292, 294, 416, 461, 463, 464 |
| 450 | 645 | 4189 | 1.22 | 295, 296, 445, 448, 464 |
| 451 | 646 | 4191, 4192 | 0.07 | 291, 298, 437, 447, 452 |
| 452 | 647 | 4194, 4198 | 6.37 | 289, 291, 298, 436, 437, 447, 451 |
| 453 | 648 | 4203, 4205, 4210, 4207 | 8.74 | 229, 259, 417, 455, 456, 460, 461 |
| 454 | 649 | 4211, 4215 | 5.31 | 257, 290, 328, 331, 432, 434 |
| 455 | 649 | 4214 | 2.57 | 256, 259, 453, 456, 457 |
| 456 | 650 | 4221, 4222, 4219, 4220, | 65.20 | 229, 235, 256, 259, 453, 455, 457, |
| | | 4217 | | 459, 460 |
| 457 | 651 | 4232, 4223, 4228, 4227, | 62.74 | 207, 213, 214, 235, 236, 256, 330, |
| | | 4225, 4224, 4231, 4230, | | 455, 456, 458, 459 |
| | | 4233 | | |
| 458 | 652 | 4241, 4237, 4240, 4234, | 37.98 | 208, 330, 421, 422, 425, 429, 430, |
| | | 4239, 4236, 4238, 4235 | | 457, 459 |
| 459 | 653 | 4248, 4247, 4246 | 41.52 | 419, 420, 421, 456, 457, 458, 460 |
| 460 | 655 | 4261, 4260 | 8.75 | 417, 419, 453, 456, 459 |
| 461 | 657 | 4279, 4278, 4276, 4275 | 44.42 | 229, 292, 294, 416, 417, 449, 453, |
| | | | | 463 |
| 462 | 658 | 4285, 4284 | 0.12 | 412, 415, 445, 464 |
| 463 | 658 | 4283 | 2.40 | 416, 449, 461, 464 |
| 464 | 659 | 4289, 4290, 4287, 4296, | 176.97 | 294, 295, 296, 415, 416, 445, 449, |
| | | 4295, 4293, 4288, 4291, | | 450, 462, 463 |
| | | 4292 | | |
| 465 | 668 | 4302, 4298, 4301, 4300, | 166.60 | 466, 467 |
| | | 4299, 4297 | | |
| 466 | 669 | 4310, 4309, 4304, 4308, | 158.48 | 411, 412, 465, 467, 468 |
| | | 4307, 4303, 4311, 4306, | | |
| | | 4305 | | |
| 467 | 670 | 4316, 4319, 4317, 4313, | 74.99 | 412, 441, 442, 444, 445, 465, 466, |
| | | 4318, 4312, 4320 | | 468 |
| 468 | 671 | 4325, 4321, 4324 | 41.59 | 409, 411, 441, 443, 466, 467, 469 |
| 469 | 673 | 4333, 4339, 4337, 4338 | 14.52 | 407, 408, 409, 439, 443, 468 |
| 470 | 675 | 4351, 4350, 4349, 4348 | 16.87 | 405, 407, 433, 434, 436, 437, 439, |
| | | | | 471 |
| 471 | 677 | 4362, 4364 | 4.34 | 367, 368, 405, 433, 434, 436, 470 |
| 472 | 677 | 4363 | 0.26 | 367, 403, 404, 405 |
| 473 | 678 | 4370, 4369 | 5.29 | 404, 405, 406, 423, 424, 428 |
| 474 | 679 | 4374 | 0.00 | 251, 427, 431, 475 |
| 475 | 680 | 4386, 4387, 4383, 4384, | 96.51 | 251, 402, 404, 427, 428, 431, 474, |
| | | 4381, 4378 | | 476, 477 |
| 476 | 681 | 4393, 4388, 4391, 4392, | 35.08 | 248, 249, 251, 335, 400, 402, 475, |
| | | 4390 | | 477 |
| 477 | 682 | 4404, 4400, 4399, 4398, | 193.94 | 366, 398, 399, 400, 401, 402, 475, |
| | | 4401, 4395, 4403, 4397, | | 476 |
| | | 4394, 4396 | | |
| 478 | 61 | 4, 2, 6, 3, 1, 5, 7 | 179.13 | 479, 480, 481, 502, 556, 557, 558 |
| 479 | 62 | 8, 12, 11 | 17.93 | 478, 481, 502, 550, 556, 557 |
| 480 | 62 | 9 | 0.07 | 478, 502, 557, 558 |
| 481 | 63 | 18, 13, 19, 14, 17 | 64.80 | 118, 478, 479, 482, 483, 550, 558 |
| 482 | 64 | 20, 29, 25, 30, 23, 22, 27, | 67.28 | 481, 483, 484, 499, 546, 550, 561 |
| | | 24 | | |
| 483 | 65 | 32, 33, 38, 35, 40, 36 | 59.47 | 118, 481, 482, 484, 560 |
| 484 | 66 | 48, 47, 50, 44, 42, 43, 51, | 133.23 | 116, 482, 483, 485, 486, 487, 489, |
| | | 41, 46 | | 493, 494, 560, 561, 562 |
| 485 | 67 | 53, 57, 52, 56 | 5.75 | 114, 115, 116, 484, 487, 488, 560, |
| | | | | 562, 564 |
| 486 | 67 | 55, 54 | 3.86 | 484, 487, 489, 494 |
| 487 | 68 | 62, 61, 60, 58, 59 | 106.49 | 484, 485, 486, 488, 489, 494 |
| 488 | 69 | 67, 68, 72, 64, 69, 63, 73, | 73.36 | 115, 116, 133, 136, 137, 485, 487, |
| | | 70, 71 | | 489, 490, 491 |
| 489 | 70 | 80, 77, 76, 78, 75, 74, 81, | 94.58 | 484, 486, 487, 488, 490, 493, 494 |
| | | 79 | | |
| 490 | 71 | 82, 87, 86, 88, 83, 84, 85 | 123.51 | 488, 489, 491, 492, 493, 566, 567 |
| 491 | 72 | 102, 98, 97, 90, 95, 100 | 41.34 | 131, 137, 488, 490, 566, 567 |
| 492 | 72 | 91 | 0.01 | 490, 493, 495, 566 |
| 493 | 73 | 109, 106, 113, 107, 112, | 44.93 | 484, 489, 490, 492, 495, 496, 499, |
| | | 110 | | 561, 566 |
| 494 | 73 | 109, 112 | 0.55 | 484, 486, 487, 489 |
| 495 | 74 | 115, 118, 116, 117, 120, | 57.42 | 54, 90, 91, 92, 93, 492, 493, 496, |
| | | 121 | | 498, 563, 565, 566 |
| 496 | 75 | 128, 124, 127, 126, 125 | 90.70 | 493, 495, 497, 498, 499, 561 |
| 497 | 76 | 130, 129, 131, 132 | 25.28 | 496, 498, 499, 540, 541, 542, 543 |
| 498 | 77 | 138, 133, 137, 139 | 25.16 | 94, 495, 496, 497, 530, 539, 540, |
| | | | | 563 |
| 499 | 78 | 151 | 8.84 | 482, 493, 496, 497, 543, 546, 561 |
| 500 | 81 | 171 | 2.79 | 501, 536, 538, 558, 559 |
| 501 | 82 | 176 | 1.63 | 500, 503, 538, 558 |
| 502 | 83 | 188, 189, 182, 185, 187, | 104.40 | 478, 479, 480, 503, 504, 505, 555, |
| | | 186 | | 556, 557, 558 |
| 503 | 84 | 193, 194, 191, 198, 196, | 153.84 | 122, 501, 502, 504, 506, 538, 558 |
| | | 190, 197, 195, 192 | | |
| 504 | 85 | 205, 203, 199, 204, 207, | 164.54 | 502, 503, 505, 506, 507, 510 |
| | | 202, 200, 201, 206 | | |
| 505 | 86 | 213, 208, 209 | 4.50 | 502, 504, 510, 555 |
| 506 | 86 | 210, 211 | 11.10 | 503, 504, 507, 508, 538 |
| 507 | 87 | 224, 222, 216, 221, 220, | 115.86 | 504, 506, 508, 509, 510 |
| | | 223, 219 | | |
| 508 | 88 | 226, 225, 230, 229, 232, | 51.33 | 506, 507, 509, 511, 532, 533, 538 |
| | | 231 | | |
| 509 | 89 | 236, 234, 237, 233, 238 | 40.41 | 507, 508, 510, 511, 512 |
| 510 | 90 | 245, 244, 243, 242, 247, | 61.77 | 504, 505, 507, 509, 512, 513, 555 |
| | | 246, 240 | | |
| 511 | 92 | 256, 259, 258, 262, 261, | 71.57 | 508, 509, 512, 514, 532 |
| | | 260 | | |
| 512 | 93 | 267, 266, 265, 268, 264, | 162.10 | 509, 510, 511, 513, 514, 515 |
| | | 270, 273, 269, 272, 263 | | |
| 513 | 94 | 274, 275, 279 | 2.64 | 510, 512, 515, 554, 555 |
| 514 | 96 | 287, 293, 292, 290, 289, | 126.23 | 511, 512, 515, 516, 517, 529, 532 |
| | | 295, 291, 296, 288 | | |
| 515 | 97 | 300, 298, 301, 302, 297, | 124.68 | 512, 513, 514, 517, 518, 552, 554 |
| | | 307, 304, 306, 303 | | |
| 516 | 99 | 320, 318, 322, 324, 323, | 42.34 | 514, 517, 519, 523, 526, 528, 529 |
| | | 319 | | |
| 517 | 100 | 329, 326, 328, 325, 327 | 65.08 | 514, 515, 516, 518, 519, 520 |
| 518 | 101 | 337, 333, 335, 334, 330, | 44.53 | 515, 517, 520, 521, 549, 552 |
| | | 338, 336, 331 | | |
| 519 | 103 | 348, 347, 346, 345 | 68.64 | 516, 517, 520, 522, 523, 525 |
| 520 | 104 | 351, 355, 359, 356, 358, | 209.17 | 517, 518, 519, 521, 522 |
| | | 350, 352, 354, 349, 353 | | |
| 521 | 105 | 364, 362, 363, 361, 367, | 142.46 | 518, 520, 522, 524, 544, 545, 548, |
| | | 365, 370, 366, 369 | | 549, 551 |
| 522 | 106 | 374, 373, 372, 371 | 71.43 | 519, 520, 521, 523, 524, 525 |
| 523 | 107 | 378, 377 | 5.10 | 516, 519, 522, 525, 526 |
| 524 | 107 | 382, 385, 383, 376, 379, | 67.20 | 521, 522, 525, 542, 544, 545 |
| | | 384, 386, 381, 380 | | |
| 525 | 108 | 393, 390, 391, 389, 388, | 166.01 | 519, 522, 523, 524, 526, 527, 528, |
| | | 394, 392, 387 | | 540, 541, 542 |
| 526 | 109 | 398, 395, 400 | 15.95 | 516, 523, 525, 528 |
| 527 | 109 | 396, 397 | 1.87 | 525, 528, 540, 541 |
| 528 | 110 | 406, 403, 409, 410, 408, | 124.22 | 516, 525, 526, 527, 529, 530, 540 |
| | | 407, 402 | | |
| 529 | 111 | 411, 415, 416, 417, 414 | 26.62 | 514, 516, 528, 530, 531, 532 |
| 530 | 112 | 426, 423, 421, 425, 420, | 77.72 | 95, 498, 528, 529, 531, 539, 540 |
| | | 422 | | |
| 531 | 113 | 431, 427, 433, 429, 428, | 40.82 | 95, 96, 100, 529, 530, 532, 539 |
| | | 435 | | |
| 532 | 114 | 437, 440, 443, 441 | 29.20 | 100, 508, 511, 514, 529, 531, 533 |
| 533 | 116 | 463, 464, 459, 458, 462, | 67.56 | 100, 508, 532, 534, 537, 538 |
| | | 461, 456 | | |
| 534 | 117 | 465, 467, 466, 468 | 29.81 | 99, 100, 104, 122, 533, 535, 537, |
| | | | | 538 |
| 535 | 118 | 471, 472 | 9.22 | 122, 534, 536, 537, 538 |
| 536 | 119 | 484, 478 | 19.60 | 120, 122, 500, 535, 538, 559 |
| 537 | 119 | 479 | 0.32 | 533, 534, 535, 538 |
| 538 | 120 | 489, 485, 491, 490, 486 | 11.62 | 500, 501, 503, 506, 508, 533, 534, |
| | | | | 535, 536, 537 |
| 539 | 123 | 514 | 7.66 | 52, 94, 95, 498, 530, 531, 563 |
| 540 | 125 | 525, 526, 527, 529, 528, | 116.57 | 497, 498, 525, 527, 528, 530, 541 |
| | | 530, 524 | | |
| 541 | 126 | 534, 531, 533, 532 | 9.49 | 497, 525, 527, 540, 542 |
| 542 | 127 | 539, 540, 544, 543 | 42.94 | 497, 524, 525, 541, 543, 544 |
| 543 | 128 | 547, 545, 546, 548 | 31.00 | 497, 499, 542, 544, 546, 547 |
| 544 | 129 | 551, 554, 556, 555, 550, | 106.25 | 521, 524, 542, 543, 545, 546, 547, |
| | | 549, 553, 552 | | 548 |
| 545 | 130 | 564, 558 | 1.85 | 521, 524, 544, 548 |
| 546 | 131 | 569, 565, 571 | 20.97 | 482, 499, 543, 544, 547, 550 |
| 547 | 132 | 581, 576, 575, 573, 580, | 130.42 | 543, 544, 546, 548, 550, 551 |
| | | 577, 579, 578 | | |
| 548 | 133 | 586, 582, 583 | 3.72 | 521, 544, 545, 547, 551 |
| 549 | 133 | 588, 585 | 11.25 | 518, 521, 551, 552 |
| 550 | 135 | 597, 599, 598, 601 | 31.33 | 479, 481, 482, 546, 547, 551, 553, |
| | | | | 556 |
| 551 | 136 | 607, 606, 610, 605, 609, | 152.02 | 521, 547, 548, 549, 550, 552, 553, |
| | | 604, 611, 608 | | 554 |
| 552 | 137 | 613, 619 | 2.29 | 515, 518, 549, 551, 554 |
| 553 | 137 | 614, 615 | 7.06 | 550, 551, 554, 555, 556 |
| 554 | 138 | 625, 621, 624, 620, 626 | 62.79 | 513, 515, 551, 552, 553, 555 |
| 555 | 139 | 627, 631, 635, 634, 628, | 65.01 | 502, 505, 510, 513, 553, 554, 556 |
| | | 636 | | |
| 556 | 140 | 640, 637, 641 | 3.52 | 478, 479, 502, 550, 553, 555 |
| 557 | 140 | 640 | 0.33 | 478, 479, 480, 502, 558 |
| 558 | 141 | 650, 647, 645, 651, 649 | 49.75 | 118, 478, 480, 481, 500, 501, 502, |
| | | | | 503, 557, 559 |
| 559 | 142 | 662, 663, 661 | 7.25 | 118, 120, 500, 536, 558 |
| 560 | 144 | 680, 678, 677, 679 | 6.90 | 116, 117, 118, 483, 484, 485, 562, |
| | | | | 564 |
| 561 | 145 | 689 | 0.99 | 482, 484, 493, 496, 499 |
| 562 | 145 | 684 | 0.52 | 484, 485, 560, 564 |
| 563 | 146 | 697, 694 | 5.10 | 92, 94, 495, 498, 539 |
| 564 | 147 | 703, 702 | 3.82 | 114, 117, 485, 560, 562 |
| 565 | 148 | 708, 709 | 0.44 | 90, 91, 93, 495 |
| 566 | 148 | 708, 709 | 1.81 | 90, 490, 491, 492, 493, 495, 567 |
| 567 | 150 | 723, 721, 722, 726, 724, | 43.72 | 87, 89, 90, 131, 490, 491, 566, 568, |
| | | 725, 727 | | 569 |
| 568 | 151 | 732, 730, 731, 728 | 28.95 | 28, 67, 87, 89, 130, 567, 569, 570 |
| 569 | 152 | 741, 740, 739 | 3.60 | 130, 131, 567, 568 |
| 570 | 152 | 734, 735, 736 | 11.08 | 67, 130, 181, 182, 568 |

TABLE 5
Potential linear epitopes identified on the structure 2P4E.
The first column identifies the starting residue for the n-mer
and the remaining columns show the largest connected solvent
accessible surface area for each n-mer which fulfill the critera
for being a potential linear epitope.

| First | | | | | | | 22- |
|---|---|---|---|---|---|---|---|
| residue | 16-mer | 17-mer | 18-mer | 19-mer | 20-mer | 21-mer | mer |
| . . . | . . . | . . . | . . . | . . . | . . . | . . . | . . . |
| 71 | — | — | — | — | — | — | 946 |
| 72 | — | — | — | — | — | 946 | 948 |
| 73 | — | — | — | — | 946 | 948 | 948 |
| 74 | — | — | — | 946 | 948 | 948 | 1075 |
| 75 | — | — | 946 | 948 | 948 | 1075 | 1199 |
| 76 | — | 946 | 948 | 948 | 1075 | 1199 | 1199 |
| 77 | 946 | 948 | 948 | 1075 | 1199 | 1199 | 1242 |
| 78 | 948 | 948 | 1075 | 1199 | 1199 | 1242 | 1307 |
| 79 | 948 | 1075 | 1199 | 1199 | 1242 | 1307 | 1351 |
| 80 | 1075 | 1199 | 1199 | 1242 | 1307 | 1351 | 1351 |
| 81 | 1199 | 1199 | 1242 | 1307 | 1351 | 1351 | 1420 |
| 82 | 1197 | 1239 | 1304 | 1349 | 1349 | 1417 | 1626 |
| 83 | 1237 | 1302 | 1347 | 1347 | 1416 | 1625 | 1767 |
| 84 | 1198 | 1243 | 1243 | 1311 | 1520 | 1663 | 1734 |
| 85 | 1089 | 1089 | 1157 | 1366 | 1509 | 1580 | 1653 |
| 86 | 924 | 993 | 1202 | 1344 | 1416 | 1488 | 1654 |
| 87 | 977 | 1186 | 1329 | 1400 | 1473 | 1639 | 1656 |
| 88 | 1070 | 1213 | 1284 | 1357 | 1523 | 1540 | 1665 |
| 89 | 1162 | 1233 | 1305 | 1471 | 1489 | 1613 | 1640 |
| 90 | 1193 | 1265 | 1431 | 1449 | 1573 | 1600 | 1677 |
| 91 | 1203 | 1369 | 1387 | 1511 | 1538 | 1616 | 1656 |
| 92 | 1369 | 1387 | 1511 | 1538 | 1616 | 1656 | 1686 |
| 93 | 1315 | 1440 | 1466 | 1544 | 1585 | 1614 | 1614 |
| 94 | 1278 | 1304 | 1382 | 1423 | 1452 | 1452 | 1519 |
| 95 | 1302 | 1379 | 1420 | 1449 | 1449 | 1517 | 1547 |
| 96 | 1379 | 1420 | 1449 | 1449 | 1517 | 1547 | 1556 |
| 97 | 1294 | 1323 | 1323 | 1391 | 1420 | 1430 | 1450 |
| 98 | 1198 | 1198 | 1266 | 1296 | 1305 | 1325 | 1336 |
| 99 | 1198 | 1266 | 1296 | 1305 | 1325 | 1336 | 1336 |
| 100 | 1224 | 1253 | 1263 | 1283 | 1294 | 1294 | 1294 |
| 101 | 1188 | 1198 | 1217 | 1229 | 1229 | 1229 | 1237 |
| 102 | 1153 | 1173 | 1185 | 1185 | 1185 | 1192 | 1192 |
| 103 | 1173 | 1185 | 1185 | 1185 | 1192 | 1192 | 1309 |
| 104 | 1116 | 1116 | 1116 | 1124 | 1124 | 1240 | 1250 |
| 105 | 907 | 907 | 914 | 914 | 1031 | 1040 | 1083 |
| 106 | — | — | — | — | — | 941 | 972 |
| 107 | — | — | — | — | — | 901 | 1007 |
| 108 | — | — | — | — | — | 934 | 936 |
| 109 | — | — | — | — | — | — | — |
| 110 | — | — | — | — | — | — | 904 |
| . . . | . . . | . . . | . . . | . . . | . . . | . . . | . . . |
| 144 | — | — | — | — | — | — | 1025 |
| 145 | — | — | — | — | — | 1025 | — |
| 146 | — | — | — | — | 1025 | — | 1389 |
| 147 | — | — | — | 1025 | — | 1389 | 1389 |
| 148 | — | — | 1025 | — | 1389 | 1389 | — |
| 149 | — | 1025 | — | 1389 | 1389 | — | — |
| 150 | 1025 | — | 1389 | 1389 | — | — | — |
| 151 | — | 1389 | 1389 | — | — | — | — |
| 152 | 1389 | 1389 | — | — | — | — | — |
| 153 | 1389 | — | — | — | — | — | — |
| . . . | . . . | . . . | . . . | . . . | . . . | . . . | . . . |
| 182 | — | — | — | — | — | — | 943 |
| 183 | — | — | — | — | — | 943 | 970 |
| 184 | — | — | — | — | 935 | 961 | 1058 |
| 185 | — | — | — | 935 | 961 | 1058 | 1105 |
| 186 | — | — | 935 | 961 | 1058 | 1105 | 1152 |
| 187 | — | 935 | 961 | 1058 | 1105 | 1152 | 1183 |
| 188 | 934 | 961 | 1057 | 1104 | 1151 | 1183 | 1347 |
| 189 | 928 | 1025 | 1072 | 1119 | 1150 | 1314 | 1399 |
| 190 | 1006 | 1054 | 1100 | 1132 | 1296 | 1381 | 1525 |
| 191 | 1010 | 1057 | 1088 | 1252 | 1338 | 1481 | 1481 |
| 192 | 1024 | 1056 | 1220 | 1305 | 1449 | 1449 | — |
| 193 | 949 | 1113 | 1199 | 1343 | 1343 | — | — |
| 194 | 1113 | 1198 | 1342 | 1342 | — | — | — |
| 195 | 1071 | 1215 | 1215 | — | — | — | — |
| 196 | 1214 | 1214 | — | — | — | — | — |
| 197 | 1214 | — | — | — | — | — | — |
| . . . | . . . | . . . | . . . | . . . | . . . | . . . | . . . |
| 409 | — | — | — | — | — | — | 913 |
| 410 | — | — | — | — | — | 913 | 992 |
| 411 | — | — | — | — | 913 | 992 | 1019 |
| 412 | — | — | — | 913 | 992 | 1019 | 1090 |
| 413 | — | — | 912 | 991 | 1018 | 1089 | 1118 |
| 414 | — | 911 | 990 | 1017 | 1088 | 1117 | 1130 |
| 415 | 911 | 990 | 1017 | 1088 | 1117 | 1130 | 1141 |
| 416 | 990 | 1017 | 1088 | 1117 | 1130 | 1141 | 1172 |
| 417 | 991 | 1062 | 1091 | 1104 | 1115 | 1146 | 1166 |
| 418 | 993 | 1022 | 1035 | 1046 | 1077 | 1097 | 1104 |
| 419 | 993 | 1006 | 1017 | 1048 | 1068 | 1075 | 1076 |
| 420 | 998 | 1009 | 1041 | 1060 | 1067 | 1068 | 1069 |
| 421 | 969 | 1000 | 1020 | 1027 | 1028 | 1028 | 1038 |
| 422 | 940 | 959 | 967 | 967 | 968 | 978 | 978 |
| . . . | . . . | . . . | . . . | . . . | . . . | . . . | . . . |
| 458 | 925 | 927 | 1054 | 1067 | — | — | — |
| 459 | — | 1022 | 1035 | — | — | — | — |
| 460 | 983 | 996 | — | — | — | — | — |
| 461 | 969 | — | — | — | — | — | — |
| . . . | . . . | . . . | . . . | . . . | . . . | . . . | . . . |
| 535 | 1016 | 1021 | — | — | — | — | — |
| 536 | 982 | — | — | — | — | — | — |
| . . . | . . . | . . . | . . . | . . . | . . . | . . . | . . . |
| 609 | 1190 | 1203 | — | — | — | — | — |
| 610 | 1075 | — | — | — | — | — | — |
| . . . | . . . | . . . | . . . | . . . | . . . | . . . | . . . |

TABLE 6
Selected PCSK9 immunogens.

| | | | | | Com- |
|---|---|---|---|---|---|
| | Start | | | | pact- |
| ID | Pos. | Length | Sequence | SASA | ness |
| 1 | 153 | 16 | SIPWNLERITPPRYRA | 1389.00 | 1.74 |
| 2 | 188 | 17 | SIQSDHREIEGRVMVTD | 934.19 | 1.36 |
| 3 | 419 | 22 | SAKDVINEAWFPEDQRVLTPNL | 1075.00 | 1.46 |
| 4 | 91 | 19 | SERTARRLQAQAARRGYLT | 1386.97 | 1.67 |
| 5 | 487 | 20 | SSFSRSGKRRGERMEAQGGK | 487.57 | 1.49 |

TABLE 7
Cross-reactivity of polyclonal sera to recombinant hPCSK9.

| Immunogen | | | Prebleed |
|---|---|---|---|
| ID | Rabbit | O.D.^{†} | O.D.^{‡} |
| 1 | 1 | 5.11 | 0.09 |
| 1 | 2 | 1.31 | 0.18 |
| 2 | 3 | 0.97 | 0.12 |
| 2 | 4 | 1.27 | 0.13 |
| 3 | 5 | 3.31 | 0.14 |
| 3 | 6 | 2.48 | 0.24 |
| 4 | 7 | 0.02 | 0.07 |
| 4 | 8 | 0.02 | 0.08 |
| 5 | 9 | 0.35 | 0.04 |
| 5 | 10 | 0.14 | 0.05 |

### EXAMPLE 3

### Generating Conformational Epitopes

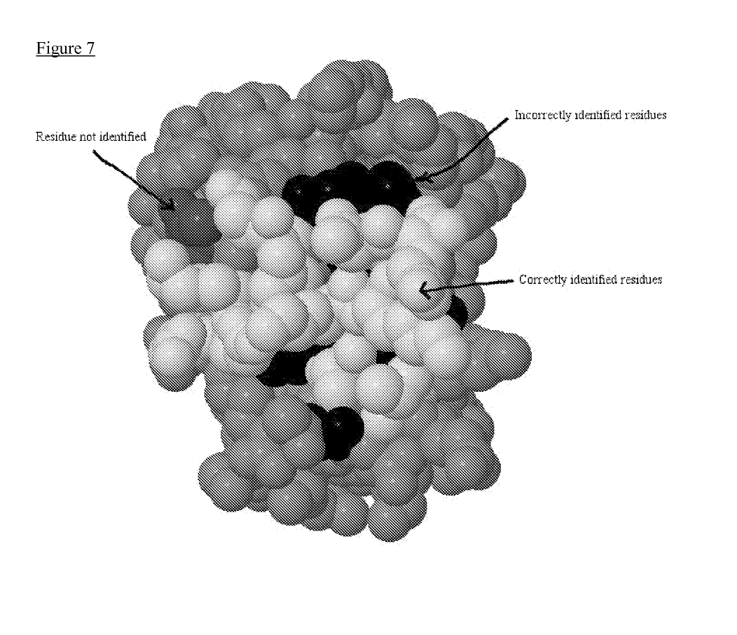

An algorithm for constructing all potential conformation epitopes was applied to the structure of horse cytochrome C (PDB structure 1WEJ) which is in complex with a Fab. The true conformational epitope was identified as residues on the antigen (chain F in the structure) having atoms within the van der Waals radii+1 Å of the Fab. The true epitope was thus considered to be constituted by residues 3, 36, 37, 58, 60, 61, 62, 96, 99, 100, 103, 104 and had a solvent accessible surface area of 968 Å². The epitope is shown in FIG. 6 where the conformational epitope is in light grey.

The residue level graph was generated for chain F of 1 WEJ, using the method described above, and it contained 126 vertices as shown in Table 8.

All potential conformational epitopes, corresponding to a surface area of 1000 Å² were computed as follows. For each vertex, vᵢ, i=0, . . . , 125 in the residue level graph:
Initialize the set of vertices L={vᵢ}.
Add the vertex, not in L, which corresponds to the surface with the smallest distance to the surface corresponding to vᵢ and which has an edge to a vertex in L, to L.
Repeat this addition of vertices until the sum of surface areas represented by the vertices in L reaches 1000 Å².
The set of residues represented by L corresponds to a potential conformational epitope centered at vᵢ of size 1000 Å².

Following this process generated the 125 unique potential conformational epitopes shown in Table 9.

We observed that the computed epitopes with IDs 13 and 96 identified 11 of the 12 residues in the true epitope and captured 95% and 96% respectively of the surface area of the true epitope. Increasing the threshold for the surface area of the computed epitopes enabled all 12 residues in the true epitope to be identified but also increased the number of residues in the predicted epitope which were not in the true epitope.

FIG. 7 shows Chain F of structure 1WEJ showing the true epitope and residues in the predicted epitope 13. The residues annotated as correctly identified are part of both the true epitope and the predicted epitope. Residues annotated as incorrectly identified are part of the predicted epitope but not part of the true epitope. The residue annotated as not identified is part of the true epitope but not part of the predicted epitope.

Nonetheless this example shows that the method presented herein is able to identify potential epitopes with high accuracy.

TABLE 8
Residue level graph generated from chain F of structure 1WEJ.

| Vertex | Residue | | |
|---|---|---|---|
| ID | ID | SASA | Vertex IDs of Neighbors |
| 0 | 1 | 73.13 | 1, 2, 111, 112, 116 |
| 1 | 2 | 58.17 | 0, 2, 3, 4, 112 |
| 2 | 3 | 51.46 | 0, 1, 3, 5, 116, 117, 121 |
| 3 | 4 | 141.28 | 1, 2, 4, 5, 6 |
| 4 | 5 | 108.74 | 1, 3, 6, 7, 112 |
| 5 | 7 | 113.23 | 2, 3, 6, 10, 117 |
| 6 | 8 | 132.50 | 3, 4, 5, 7, 10, 11 |
| 7 | 9 | 25.18 | 4, 6, 11, 12, 103, 109, 112 |
| 8 | 10 | 0.27 | 13, 17, 34, 113, 118 |
| 9 | 10 | 9.80 | 10, 14, 18, 19, 20, 117 |
| 10 | 11 | 91.91 | 5, 6, 9, 11, 14, 15, 117 |
| 11 | 12 | 135.12 | 6, 7, 10, 12, 15 |
| 12 | 13 | 78.56 | 7, 11, 13, 15, 98, 100, 101, 103, 109 |
| 13 | 14 | 18.09 | 8, 12, 15, 16, 17, 34, 80, 98, 104, |
| | | | 113, 114, 118 |
| 14 | 15 | 34.14 | 9, 10, 15, 18, 19, 28 |
| 15 | 16 | 112.82 | 10, 11, 12, 13, 14, 16, 28, 29 |
| 16 | 17 | 40.98 | 13, 15, 17, 29, 30 |
| 17 | 18 | 21.83 | 8, 13, 16, 30, 31, 34, 95 |
| 18 | 18 | 1.91 | 9, 14, 19, 28 |
| 19 | 19 | 20.75 | 9, 14, 18, 20, 21, 26, 28 |
| 20 | 20 | 16.15 | 9, 19, 21, 117, 122 |
| 21 | 21 | 97.04 | 19, 20, 22, 23, 24, 26, 122, 125 |
| 22 | 22 | 159.85 | 21, 23, 35, 125 |
| 23 | 23 | 76.97 | 21, 22, 24, 25, 26, 32, 35 |
| 24 | 24 | 0.71 | 21, 23, 26 |
| 25 | 24 | 9.41 | 23, 26, 27, 32 |
| 26 | 25 | 134.87 | 19, 21, 23, 24, 25, 27, 28 |
| 27 | 26 | 61.28 | 25, 26, 28, 32, 50, 52, 53, 54 |
| 28 | 27 | 76.46 | 14, 15, 18, 19, 26, 27, 29, 54 |
| 29 | 28 | 96.59 | 15, 16, 28, 30, 54, 55, 94 |
| 30 | 29 | 7.79 | 16, 17, 29, 31, 55 |
| 31 | 30 | 14.91 | 17, 30, 33, 34, 49, 55, 58, 64 |
| 32 | 31 | 14.67 | 23, 25, 27, 35, 40, 50 |
| 33 | 31 | 0.09 | 31, 34, 41, 49, 58 |
| 34 | 32 | 24.37 | 8, 13, 17, 31, 33, 37, 41, 118 |
| 35 | 33 | 30.98 | 22, 23, 32, 36, 40, 50, 124, 125 |
| 36 | 34 | 29.70 | 35, 38, 39, 40, 123, 124 |
| 37 | 35 | 8.37 | 34, 41, 71, 76, 118 |
| 38 | 36 | 46.82 | 36, 39, 40, 72, 73, 119, 120, 123, 124 |
| 39 | 37 | 56.34 | 36, 38, 40, 42, 70, 72 |
| 40 | 38 | 43.99 | 32, 35, 36, 38, 39, 42, 47, 50, 52 |
| 41 | 38 | 4.92 | 33, 34, 37, 43, 48, 49, 58, 71 |
| 42 | 39 | 91.30 | 39, 40, 44, 47, 68, 69, 70 |
| 43 | 39 | 0.97 | 41, 45, 46, 48, 71 |
| 44 | 40 | 1.07 | 42, 47, 65, 68 |
| 45 | 40 | 0.01 | 43, 46, 71 |
| 46 | 41 | 2.23 | 43, 45, 48, 58, 64, 71 |
| 47 | 42 | 81.51 | 40, 42, 44, 51, 52, 65 |
| 48 | 42 | 0.65 | 41, 43, 46, 49, 58 |
| 49 | 43 | 0.28 | 31, 33, 41, 48, 58 |
| 50 | 43 | 2.53 | 27, 32, 35, 40, 52 |
| 51 | 43 | 2.10 | 47, 52, 53, 56, 65 |
| 52 | 44 | 114.60 | 27, 40, 47, 50, 51, 53, 56 |
| 53 | 45 | 78.60 | 27, 51, 52, 54, 56, 57 |
| 54 | 46 | 17.40 | 27, 28, 29, 53, 57, 94 |
| 55 | 46 | 5.19 | 29, 30, 31, 58, 94 |
| 56 | 46 | 11.26 | 51, 52, 53, 57, 59, 65 |
| 57 | 47 | 113.97 | 53, 54, 56, 59, 65, 94 |
| 58 | 48 | 13.83 | 31, 33, 41, 46, 48, 49, 55, 61, 64, 94 |
| 59 | 48 | 14.07 | 56, 57, 60, 62, 65, 94 |
| 60 | 49 | 33.44 | 59, 62, 63, 91, 94 |
| 61 | 49 | 1.31 | 58, 64, 93, 94 |
| 62 | 50 | 111.71 | 59, 60, 63, 65, 66 |
| 63 | 51 | 31.08 | 60, 62, 66, 67, 89, 90, 91 |
| 64 | 52 | 19.67 | 31, 46, 58, 61, 71, 79, 93, 94, 95 |
| 65 | 53 | 82.30 | 44, 47, 51, 56, 57, 59, 62, 66, 68 |
| 66 | 54 | 112.28 | 62, 63, 65, 67, 68 |
| 67 | 55 | 66.30 | 63, 66, 68, 69, 87, 88, 89, 90 |
| 68 | 56 | 43.78 | 42, 44, 65, 66, 67, 69 |
| 69 | 57 | 45.37 | 42, 67, 68, 70, 75, 88 |
| 70 | 58 | 39.36 | 39, 42, 69, 72, 75 |
| 71 | 59 | 16.26 | 37, 41, 43, 45, 46, 64, 76, 79 |
| 72 | 60 | 90.32 | 38, 39, 70, 73, 74, 75 |
| 73 | 61 | 70.13 | 38, 72, 74, 77, 115, 119 |
| 74 | 62 | 123.48 | 72, 73, 75, 77, 78 |
| 75 | 63 | 16.79 | 69, 70, 72, 74, 78, 88 |
| 76 | 64 | 5.94 | 37, 71, 79, 80, 118 |
| 77 | 65 | 37.48 | 73, 74, 78, 107, 110, 111, 115 |
| 78 | 66 | 88.88 | 74, 75, 77, 81, 82, 87, 88, 110 |
| 79 | 67 | 15.82 | 64, 71, 76, 80, 95 |
| 80 | 68 | 12.21 | 13, 76, 79, 95, 98, 104, 113, 114, 118 |
| 81 | 69 | 58.33 | 78, 82, 83, 87, 99, 100, 102, 105, 110 |
| 82 | 70 | 1.07 | 78, 81, 87, 88 |
| 83 | 70 | 43.35 | 81, 85, 86, 87, 98, 99 |
| 84 | 71 | 0.11 | 86, 96, 98 |
| 85 | 71 | 0.03 | 83, 86, 98, 99 |
| 86 | 72 | 147.58 | 83, 84, 85, 87, 90, 91, 92, 96, 98 |
| 87 | 73 | 138.34 | 67, 78, 81, 82, 83, 86, 88, 90 |
| 88 | 74 | 18.65 | 67, 69, 75, 78, 82, 87, 90 |
| 89 | 75 | 1.35 | 63, 67, 90 |
| 90 | 76 | 96.21 | 63, 67, 86, 87, 88, 89, 91 |
| 91 | 77 | 58.16 | 60, 63, 86, 90, 92, 94 |
| 92 | 78 | 16.86 | 86, 91, 94, 96, 97 |
| 93 | 78 | 1.86 | 61, 64, 94, 95 |
| 94 | 79 | 102.97 | 29, 54, 55, 57, 58, 59, 60, 61, 64, 91, 92, |
| | | | 93, 95, 97 |
| 95 | 80 | 44.42 | 17, 64, 79, 80, 93, 94, 97, 98 |
| 96 | 80 | 4.91 | 84, 86, 92, 97, 98 |
| 97 | 81 | 171.92 | 92, 94, 95, 96, 98, 99 |
| 98 | 82 | 50.06 | 12, 13, 80, 83, 84, 85, 86, 95, 96, 97, 99, |
| | | | 100, 104, 114 |
| 99 | 83 | 98.76 | 81, 83, 85, 97, 98, 100 |
| 100 | 84 | 23.65 | 12, 81, 98, 99, 101, 102, 105 |
| 101 | 85 | 2.95 | 12, 100, 105, 106, 109 |
| 102 | 85 | 0.02 | 81, 100, 105 |
| 103 | 85 | 0.18 | 7, 12, 109 |
| 104 | 85 | 0.05 | 13, 80, 98, 114 |
| 105 | 86 | 182.79 | 81, 100, 101, 102, 106, 107, 109, 110 |
| 106 | 87 | 130.60 | 101, 105, 107, 108, 109 |
| 107 | 88 | 124.53 | 77, 105, 106, 108, 110, 111 |
| 108 | 89 | 77.79 | 106, 107, 109, 111, 112 |
| 109 | 90 | 55.87 | 7, 12, 101, 103, 105, 106, 108, 112 |
| 110 | 91 | 25.14 | 77, 78, 81, 105, 107 |
| 111 | 92 | 53.12 | 0, 77, 107, 108, 112, 115, 116 |
| 112 | 93 | 17.64 | 0, 1, 4, 7, 108, 109, 111 |
| 113 | 94 | 0.36 | 8, 13, 80, 118 |
| 114 | 94 | 0.20 | 13, 80, 98, 104 |
| 115 | 95 | 6.01 | 73, 77, 111, 116, 119 |
| 116 | 96 | 15.19 | 0, 2, 111, 115, 119, 121 |
| 117 | 97 | 22.56 | 2, 5, 9, 10, 20, 121, 122 |
| 118 | 98 | 6.79 | 8, 13, 34, 37, 76, 80, 113 |
| 119 | 99 | 101.02 | 38, 73, 115, 116, 121, 124 |
| 120 | 99 | 0.00 | 38, 123, 124 |
| 121 | 100 | 105.26 | 2, 116, 117, 119, 122, 124, 125 |
| 122 | 101 | 16.48 | 20, 21, 117, 121, 125 |
| 123 | 102 | 0.55 | 36, 38, 120, 124 |
| 124 | 103 | 113.32 | 35, 36, 38, 119, 120, 121, 123, 125 |
| 125 | 104 | 155.22 | 21, 22, 35, 121, 122, 124 |

TABLE 9
All potential conformational epitopes generated from the residue level graph in
Table 8 using a threshold of 1000 Å² for epitope surface area. The # of correct residues is
the number of residues in the conformational epitope which are part of the true epitope.
SASA is the solvent accessible surface area of the epitope and correct SASA is the solvent
accessible surface area of the residues in the epitope which are part of the true epitope.

| Epitope | # Correct | # | | | Correct |
|---|---|---|---|---|---|
| ID | Residues | Residues | Residue IDs | SASA | SASA |
| 1 | 3 | 15 | 1, 2, 3, 4, 5, 7, 8, 9, 11, 90, 93, 96, 97, 100, 101 | 1029 | 172 |
| 2 | 2 | 14 | 1, 2, 3, 4, 5, 7, 8, 9, 87, 89, 90, 92, 93, 96 | 1054 | 67 |
| 3 | 3 | 15 | 1, 2, 3, 4, 5, 7, 8, 9, 89, 90, 92, 93, 96, 97, 100 | 1051 | 172 |
| 4 | 4 | 16 | 1, 2, 3, 4, 5, 7, 8, 9, 92, 93, 95, 96, 97, 99, 100, 101 | 1041 | 273 |
| 5 | 6 | 19 | 1, 2, 3, 4, 5, 7, 9, 36, 61, 65, 92, 93, 95, 96, 97, 99, 100, 101, | 1063 | 390 |
| | | | 102 | | |
| 6 | 2 | 16 | 1, 2, 3, 4, 5, 8, 9, 85, 87, 88, 89, 90, 92, 93, 95, 96 | 1071 | 67 |
| 7 | 5 | 14 | 1, 2, 3, 4, 5, 61, 88, 89, 92, 93, 95, 96, 99, 100 | 1003 | 343 |
| 8 | 7 | 16 | 1, 2, 3, 4, 7, 10, 20, 36, 96, 97, 99, 100, 101, 102, 103, 104 | 1040 | 588 |
| 9 | 4 | 17 | 1, 2, 3, 5, 61, 62, 65, 85, 87, 88, 89, 90, 91, 92, 93, 95, 96 | 1032 | 260 |
| 10 | 1 | 17 | 1, 2, 5, 9, 65, 69, 85, 86, 87, 88, 89, 90, 91, 92, 93, 95, 96 | 1053 | 15 |
| 11 | 6 | 36 | 1, 3, 7, 9, 10, 13, 14, 15, 18, 19, 20, 30, 31, 32, 33, 34, 35, 36, | 1092 | 390 |
| | | | 38, 59, 61, 64, 65, 67, 68, 85, 93, 94, 95, 96, 97, 98, 99, 100, | | |
| | | | 101, 102 | | |
| 12 | 9 | 20 | 1, 3, 10, 20, 22, 33, 34, 36, 37, 38, 61, 95, 96, 97, 99, 100, 101, | 1124 | 715 |
| | | | 102, 103, 104 | | |
| 13 | 11 | 18 | 1, 3, 33, 34, 36, 37, 60, 61, 62, 95, 96, 97, 99, 100, 101, 102, | 1108 | 929 |
| | | | 103, 104 | | |
| 14 | 7 | 17 | 1, 3, 36, 60, 61, 62, 63, 65, 66, 88, 89, 91, 92, 93, 95, 96, 99 | 1019 | 498 |
| 15 | 8 | 19 | 1, 36, 37, 57, 58, 60, 61, 62, 63, 65, 66, 88, 91, 92, 93, 95, 96, | 1031 | 543 |
| | | | 99, 102 | | |
| 16 | 3 | 19 | 1, 61, 62, 63, 65, 66, 69, 70, 74, 85, 86, 88, 89, 90, 91, 92, 93, | 1049 | 209 |
| | | | 95, 96 | | |
| 17 | 1 | 15 | 1, 62, 65, 66, 69, 85, 86, 87, 88, 89, 90, 91, 92, 93, 95 | 1058 | 123 |
| 18 | 3 | 16 | 2, 3, 4, 5, 7, 8, 9, 10, 11, 12, 15, 20, 96, 97, 100, 101 | 1077 | 172 |
| 19 | 1 | 13 | 2, 3, 4, 5, 7, 8, 9, 11, 12, 13, 90, 93, 97 | 1032 | 51 |
| 20 | 1 | 18 | 3, 4, 5, 7, 8, 9, 10, 11, 12, 13, 14, 68, 85, 90, 93, 94, 97, 98 | 1025 | 51 |
| 21 | 5 | 16 | 3, 4, 7, 8, 9, 10, 11, 18, 20, 21, 96, 97, 99, 100, 101, 104 | 1096 | 428 |
| 22 | 2 | 27 | 3, 5, 8, 9, 10, 11, 12, 13, 14, 18, 32, 35, 64, 65, 67, 68, 82, 84, | 1034 | 67 |
| | | | 85, 90, 92, 93, 94, 95, 96, 97, 98 | | |
| 23 | 6 | 16 | 3, 7, 10, 20, 21, 22, 33, 34, 96, 97, 99, 100, 101, 102, 103, 104 | 1038 | 541 |
| 24 | 6 | 15 | 3, 7, 20, 21, 22, 33, 34, 36, 97, 99, 100, 101, 102, 103, 104 | 1060 | 573 |
| 25 | 2 | 29 | 3, 8, 9, 10, 11, 12, 13, 14, 18, 32, 35, 64, 65, 67, 68, 71, 82, 84, | 1027 | 67 |
| | | | 85, 89, 90, 91, 92, 93, 94, 95, 96, 97, 98 | | |
| 26 | 0 | 20 | 4, 7, 8, 9, 10, 11, 12, 13, 14, 15, 16, 17, 18, 19, 20, 85, 94, 97, | 1019 | 0 |
| | | | 98, 101 | | |
| 27 | 0 | 18 | 5, 7, 8, 9, 10, 11, 12, 13, 14, 15, 16, 17, 18, 82, 84, 85, 90, 94 | 1037 | 0 |
| 28 | 0 | 14 | 5, 8, 9, 13, 84, 85, 86, 87, 88, 89, 90, 91, 92, 93 | 1039 | 0 |
| 29 | 0 | 15 | 5, 9, 13, 65, 69, 84, 85, 86, 87, 88, 89, 90, 91, 92, 93 | 1003 | 0 |
| 30 | 0 | 20 | 7, 8, 9, 10, 11, 12, 13, 14, 15, 16, 17, 18, 19, 20, 21, 32, 94, 97, | 1021 | 0 |
| | | | 98, 101 | | |
| 31 | 0 | 27 | 7, 9, 10, 11, 12, 13, 14, 15, 16, 17, 18, 19, 20, 21, 27, 29, 30, | 1015 | 0 |
| | | | 31, 32, 35, 64, 68, 85, 94, 97, 98, 101 | | |
| 32 | 1 | 17 | 7, 10, 11, 15, 18, 19, 20, 21, 22, 23, 24, 25, 31, 33, 97, 101, | 1007 | 155 |
| | | | 104 | | |
| 33 | 0 | 21 | 8, 9, 10, 11, 12, 13, 14, 15, 16, 17, 18, 68, 71, 81, 82, 83, 84, | 1126 | 0 |
| | | | 85, 90, 94, 98 | | |
| 34 | 0 | 26 | 9, 10, 11, 12, 13, 14, 15, 16, 17, 18, 19, 20, 27, 28, 29, 30, 32, | 1152 | 0 |
| | | | 67, 68, 80, 81, 82, 85, 94, 97, 98 | | |
| 35 | 0 | 22 | 9, 10, 12, 13, 14, 65, 68, 69, 71, 82, 83, 84, 85, 86, 87, 89, 90, | 1044 | 0 |
| | | | 91, 93, 94, 95, 98 | | |
| 36 | 3 | 32 | 9, 10, 13, 14, 18, 32, 35, 59, 61, 62, 63, 64, 65, 66, 67, 68, 69, | 1073 | 209 |
| | | | 70, 71, 74, 80, 82, 83, 84, 85, 90, 91, 92, 94, 95, 96, 98 | | |
| 37 | 0 | 22 | 9, 12, 13, 14, 65, 68, 69, 71, 82, 83, 84, 85, 86, 87, 89, 90, 91, | 1097 | 0 |
| | | | 92, 93, 94, 95, 98 | | |
| 38 | 0 | 18 | 9, 13, 65, 68, 69, 70, 71, 82, 83, 84, 85, 86, 87, 88, 89, 90, 91, | 1029 | 0 |
| | | | 94 | | |
| 39 | 0 | 17 | 10, 11, 12, 13, 14, 15, 16, 17, 18, 19, 20, 21, 25, 27, 28, 29, 32 | 1019 | 0 |
| 40 | 0 | 16 | 10, 11, 12, 13, 14, 15, 16, 17, 18, 19, 27, 28, 29, 80, 81, 82 | 1013 | 0 |
| 41 | 0 | 25 | 10, 11, 14, 15, 16, 17, 18, 19, 20, 21, 23, 24, 25, 26, 27, 28, 29, | 1039 | 0 |
| | | | 30, 31, 32, 35, 94, 97, 98, 101 | | |
| 42 | 0 | 21 | 10, 12, 13, 14, 16, 17, 18, 67, 68, 69, 70, 71, 72, 78, 80, 81, 82, | 1102 | 0 |
| | | | 83, 84, 85, 94 | | |
| 43 | 0 | 19 | 10, 13, 14, 15, 16, 17, 18, 19, 26, 27, 28, 29, 30, 32, 46, 79, 80, | 1017 | 0 |
| | | | 81, 82 | | |
| 44 | 0 | 22 | 10, 14, 15, 16, 17, 18, 19, 20, 21, 22, 23, 24, 25, 26, 27, 28, 29, | 1099 | 0 |
| | | | 30, 31, 32, 33, 101 | | |
| 45 | 0 | 23 | 10, 14, 15, 16, 17, 18, 19, 20, 21, 23, 24, 25, 26, 27, 28, 29, 30, | 1040 | 0 |
| | | | 31, 32, 43, 45, 46, 80 | | |
| 46 | 2 | 41 | 10, 14, 15, 16, 17, 18, 19, 20, 21, 24, 26, 27, 28, 29, 30, 31, 32, | 1049 | 47 |
| | | | 33, 34, 35, 36, 38, 39, 40, 41, 42, 43, 46, 48, 52, 59, 64, 67, 68, | | |
| | | | 80, 94, 97, 98, 99, 101, 102 | | |
| 47 | 0 | 29 | 10, 14, 15, 16, 17, 18, 19, 20, 26, 27, 28, 29, 30, 31, 32, 35, 43, | 1055 | 0 |
| | | | 46, 48, 52, 64, 67, 68, 71, 79, 80, 81, 82, 98 | | |
| 48 | 6 | 42 | 10, 14, 17, 18, 26, 28, 29, 30, 31, 32, 33, 34, 35, 36, 37, 38, 39, | 1091 | 427 |
| | | | 40, 41, 42, 43, 46, 48, 52, 58, 59, 61, 63, 64, 67, 68, 71, 78, 80, | | |
| | | | 82, 85, 94, 95, 98, 99, 102, 103 | | |
| 49 | 3 | 34 | 10, 14, 18, 28, 29, 30, 31, 32, 33, 34, 35, 36, 37, 38, 39, 40, 41, | 1007 | 143 |
| | | | 42, 43, 44, 45, 46, 48, 49, 52, 58, 59, 64, 67, 68, 78, 80, 98, | | |
| | | | 102 | | |
| 50 | 6 | 38 | 10, 14, 18, 30, 31, 32, 35, 36, 37, 38, 39, 40, 41, 42, 43, 52, 57, | 1037 | 426 |
| | | | 58, 59, 60, 61, 62, 63, 64, 65, 66, 67, 68, 69, 71, 74, 80, 82, 84, | | |
| | | | 85, 94, 95, 98 | | |
| 51 | 0 | 21 | 10, 15, 17, 18, 19, 20, 21, 22, 23, 24, 25, 26, 27, 28, 29, 30, 31, | 1024 | 0 |
| | | | 32, 43, 45, 46 | | |
| 52 | 0 | 21 | 10, 15, 18, 19, 20, 21, 22, 23, 24, 25, 26, 27, 31, 33, 34, 43, 44, | 1018 | 0 |
| | | | 45, 46, 101, 102 | | |
| 53 | 2 | 18 | 10, 15, 18, 19, 20, 21, 22, 23, 24, 25, 26, 27, 31, 33, 97, 101, | 1053 | 269 |
| | | | 103, 104 | | |
| 54 | 0 | 32 | 10, 18, 19, 20, 21, 23, 24, 26, 27, 28, 29, 30, 31, 32, 33, 34, 35, | 1040 | 0 |
| | | | 38, 39, 40, 41, 42, 43, 44, 45, 46, 48, 52, 59, 64, 98, 102 | | |
| 55 | 3 | 35 | 10, 18, 29, 30, 31, 32, 35, 36, 37, 38, 39, 40, 41, 42, 43, 46, 48, | 1001 | 143 |
| | | | 49, 52, 53, 55, 56, 57, 58, 59, 63, 64, 67, 68, 74, 78, 79, 80, 94, | | |
| | | | 98 | | |
| 56 | 0 | 17 | 13, 65, 68, 69, 70, 71, 82, 83, 84, 85, 86, 87, 88, 89, 90, 91, 94 | 1004 | 0 |
| 57 | 0 | 15 | 13, 67, 68, 69, 70, 71, 72, 73, 80, 81, 82, 83, 84, 85, 86 | 1075 | 0 |
| 58 | 0 | 17 | 13, 67, 68, 69, 70, 71, 72, 80, 81, 82, 83, 84, 85, 86, 90, 91, 94 | 1018 | 0 |
| 59 | 0 | 21 | 14, 15, 16, 17, 18, 19, 25, 26, 27, 28, 29, 30, 31, 32, 43, 46, 47, | 1027 | 0 |
| | | | 48, 52, 79, 80 | | |
| 60 | 0 | 17 | 14, 15, 16, 17, 18, 19, 25, 26, 27, 28, 29, 30, 46, 47, 79, 80, 81 | 1103 | 0 |
| 61 | 0 | 23 | 14, 17, 18, 28, 29, 30, 32, 46, 48, 49, 52, 67, 68, 71, 72, 77, 78, | 1014 | 0 |
| | | | 79, 80, 81, 82, 83, 84 | | |
| 62 | 0 | 16 | 16, 17, 18, 28, 29, 67, 71, 72, 77, 78, 79, 80, 81, 82, 83, 84 | 1017 | 0 |
| 63 | 0 | 29 | 17, 18, 19, 26, 27, 28, 29, 30, 31, 32, 35, 38, 39, 40, 41, 42, 43, | 1056 | 0 |
| | | | 44, 45, 46, 47, 48, 49, 52, 59, 67, 78, 79, 80 | | |
| 64 | 0 | 22 | 17, 18, 25, 26, 27, 28, 29, 30, 31, 32, 41, 42, 43, 44, 45, 46, 47, | 1110 | 0 |
| | | | 48, 49, 52, 53, 79 | | |
| 65 | 0 | 23 | 17, 18, 26, 27, 28, 29, 30, 31, 32, 41, 42, 43, 44, 45, 46, 47, 48, | 1022 | 0 |
| | | | 49, 52, 53, 78, 79, 80 | | |
| 66 | 0 | 21 | 17, 18, 28, 29, 30, 46, 47, 48, 49, 50, 51, 52, 67, 71, 75, 76, 77, | 1070 | 0 |
| | | | 78, 79, 80, 81 | | |
| 67 | 0 | 20 | 17, 18, 28, 29, 49, 52, 67, 70, 71, 72, 75, 76, 77, 78, 79, 80, 81, | 1066 | 0 |
| | | | 82, 83, 84 | | |
| 68 | 0 | 19 | 18, 19, 20, 21, 22, 23, 24, 25, 26, 27, 31, 33, 34, 38, 43, 44, 45, | 1002 | 0 |
| | | | 46, 102 | | |
| 69 | 1 | 19 | 18, 19, 20, 21, 22, 23, 24, 25, 26, 27, 31, 33, 34, 43, 44, 45, | 1101 | 155 |
| | | | 101, 102, 104 | | |
| 70 | 0 | 19 | 18, 19, 21, 23, 24, 25, 26, 27, 28, 29, 30, 31, 32, 43, 44, 45, 46, | 1019 | 0 |
| | | | 47, 48 | | |
| 71 | 0 | 28 | 18, 24, 26, 28, 29, 30, 31, 32, 33, 34, 35, 38, 39, 40, 41, 42, 43, | 1062 | 0 |
| | | | 44, 45, 46, 47, 48, 49, 52, 53, 59, 64, 67 | | |
| 72 | 0 | 25 | 18, 26, 29, 30, 31, 38, 39, 40, 41, 42, 43, 44, 45, 46, 47, 48, 49, | 1016 | 0 |
| | | | 50, 51, 52, 53, 59, 78, 79, 80 | | |
| 73 | 3 | 33 | 18, 29, 30, 31, 32, 34, 35, 36, 37, 38, 39, 40, 41, 42, 43, 44, 46, | 1094 | 143 |
| | | | 48, 49, 52, 53, 55, 56, 57, 58, 59, 64, 67, 68, 78, 79, 80, 98 | | |
| 74 | 0 | 27 | 18, 29, 30, 31, 32, 34, 35, 38, 39, 40, 41, 42, 43, 44, 45, 46, 47, | 1066 | 0 |
| | | | 48, 49, 52, 53, 54, 59, 64, 67, 78, 79 | | |
| 75 | 2 | 31 | 18, 29, 30, 31, 32, 35, 37, 38, 39, 40, 41, 42, 43, 46, 48, 49, 51, | 1037 | 96 |
| | | | 52, 53, 54, 55, 56, 57, 58, 59, 64, 67, 68, 78, 79, 80 | | |
| 76 | 1 | 29 | 18, 29, 30, 31, 32, 35, 38, 39, 40, 41, 42, 43, 46, 48, 49, 51, 52, | 1015 | 39 |
| | | | 53, 54, 55, 56, 57, 58, 59, 64, 67, 78, 79, 80 | | |
| 77 | 0 | 30 | 18, 29, 30, 32, 35, 40, 41, 48, 52, 59, 64, 66, 67, 68, 70, 71, 72, | 1083 | 0 |
| | | | 74, 75, 76, 78, 79, 80, 81, 82, 83, 84, 85, 94, 98 | | |
| 78 | 0 | 27 | 18, 29, 30, 39, 40, 41, 42, 43, 46, 47, 48, 49, 50, 51, 52, 53, 54, | 1072 | 0 |
| | | | 55, 56, 59, 67, 71, 75, 77, 78, 79, 80 | | |
| 79 | 2 | 17 | 19, 20, 21, 22, 23, 24, 25, 26, 31, 33, 34, 43, 44, 101, 102, 103, | 1055 | 269 |
| | | | 104 | | |
| 80 | 5 | 19 | 19, 20, 21, 22, 23, 24, 31, 33, 34, 36, 37, 38, 43, 44, 99, 101, | 1008 | 372 |
| | | | 102, 103, 104 | | |
| 81 | 6 | 16 | 20, 21, 22, 31, 33, 34, 36, 37, 38, 97, 99, 100, 101, 102, 103, | 1010 | 578 |
| | | | 104 | | |
| 82 | 7 | 16 | 20, 21, 22, 33, 34, 36, 37, 38, 96, 97, 99, 100, 101, 102, 103, | 1010 | 593 |
| | | | 104 | | |
| 83 | 0 | 18 | 22, 23, 24, 25, 26, 31, 33, 34, 38, 40, 42, 43, 44, 45, 46, 47, 48, | 1082 | 0 |
| | | | 53 | | |
| 84 | 0 | 19 | 22, 23, 24, 26, 31, 33, 34, 38, 39, 40, 42, 43, 44, 45, 46, 47, 48, | 1072 | 0 |
| | | | 49, 53 | | |
| 85 | 0 | 19 | 22, 23, 24, 26, 31, 33, 34, 38, 39, 40, 42, 43, 44, 45, 46, 47, 48, | 1039 | 0 |
| | | | 53, 102 | | |
| 86 | 6 | 22 | 22, 31, 33, 34, 36, 37, 38, 39, 40, 42, 43, 44, 46, 53, 56, 57, 58, | 1119 | 346 |
| | | | 60, 63, 99, 102, 103 | | |
| 87 | 6 | 16 | 22, 31, 33, 34, 36, 37, 38, 39, 42, 43, 44, 58, 99, 102, 103, 104 | 1084 | 512 |
| 88 | 0 | 15 | 23, 24, 25, 26, 27, 28, 31, 42, 43, 44, 45, 46, 47, 48, 53 | 1008 | 0 |
| 89 | 0 | 21 | 26, 28, 29, 30, 31, 38, 39, 40, 41, 42, 43, 44, 45, 46, 47, 48, 49, | 1012 | 0 |
| | | | 50, 52, 53, 79 | | |
| 90 | 0 | 18 | 26, 28, 29, 30, 41, 42, 43, 44, 45, 46, 47, 48, 49, 50, 51, 52, 53, | 1021 | 0 |
| | | | 79 | | |
| 91 | 0 | 20 | 28, 29, 30, 40, 41, 42, 43, 45, 46, 47, 48, 49, 50, 51, 52, 53, 54, | 1033 | 0 |
| | | | 77, 78, 79 | | |
| 92 | 0 | 22 | 29, 30, 40, 41, 42, 46, 47, 48, 49, 50, 51, 52, 53, 54, 55, 67, 75, | 1003 | 0 |
| | | | 76, 77, 78, 79, 80 | | |
| 93 | 0 | 22 | 29, 30, 41, 46, 48, 49, 50, 51, 52, 55, 67, 70, 71, 72, 74, 75, 76, | 1003 | 0 |
| | | | 77, 78, 79, 80, 81 | | |
| 94 | 2 | 19 | 31, 34, 37, 38, 39, 40, 42, 43, 44, 45, 46, 47, 48, 50, 53, 54, 56, | 1108 | 96 |
| | | | 57, 58 | | |
| 95 | 8 | 19 | 33, 34, 36, 37, 38, 39, 40, 42, 43, 56, 57, 58, 60, 61, 62, 63, 99, | 1028 | 641 |
| | | | 102, 103 | | |
| 96 | 11 | 19 | 33, 34, 36, 37, 38, 39, 58, 60, 61, 62, 63, 95, 96, 99, 100, 101, | 1152 | 916 |
| | | | 102, 103, 104 | | |
| 97 | 4 | 19 | 34, 36, 37, 38, 39, 40, 42, 43, 44, 51, 53, 54, 55, 56, 57, 58, 60, | 1016 | 233 |
| | | | 63, 74 | | |
| 98 | 6 | 18 | 34, 36, 37, 38, 39, 40, 42, 54, 55, 56, 57, 58, 60, 61, 62, 63, 66, | 1066 | 426 |
| | | | 74 | | |
| 99 | 7 | 19 | 34, 36, 37, 38, 39, 40, 55, 56, 57, 58, 60, 61, 62, 63, 65, 66, 74, | 1017 | 527 |
| | | | 95, 99 | | |
| 100 | 3 | 22 | 34, 37, 38, 39, 40, 42, 43, 46, 48, 49, 50, 51, 53, 54, 55, 56, 57, | 1027 | 186 |
| | | | 58, 60, 63, 74, 75 | | |
| 101 | 6 | 20 | 36, 37, 39, 40, 55, 56, 57, 58, 60, 61, 62, 63, 65, 66, 70, 73, 74, | 1008 | 426 |
| | | | 75, 91, 95 | | |
| 102 | 8 | 18 | 36, 37, 57, 58, 60, 61, 62, 63, 65, 66, 69, 74, 88, 91, 92, 95, 96, | 1017 | 543 |
| | | | 99 | | |
| 103 | 3 | 18 | 37, 38, 39, 40, 42, 50, 51, 53, 54, 55, 56, 57, 58, 60, 63, 74, 75, | 1030 | 186 |
| | | | 76 | | |
| 104 | 4 | 18 | 37, 38, 39, 40, 42, 51, 53, 54, 55, 56, 57, 58, 60, 62, 63, 66, 74, | 1034 | 309 |
| | | | 75 | | |
| 105 | 0 | 16 | 39, 40, 42, 43, 44, 45, 46, 47, 48, 49, 50, 51, 53, 54, 55, 56 | 1009 | 0 |
| 106 | 1 | 19 | 39, 40, 42, 47, 48, 49, 50, 51, 53, 54, 55, 56, 57, 58, 74, 75, 76, | 1059 | 39 |
| | | | 77, 78 | | |
| 107 | 1 | 17 | 39, 40, 50, 51, 53, 54, 55, 56, 57, 58, 63, 66, 73, 74, 75, 76, 77 | 1043 | 39 |
| 108 | 0 | 19 | 40, 41, 42, 46, 47, 48, 49, 50, 51, 52, 53, 54, 55, 56, 75, 76, 77, | 1023 | 0 |
| | | | 78, 79 | | |
| 109 | 0 | 24 | 40, 41, 42, 46, 48, 49, 50, 51, 52, 53, 54, 55, 56, 57, 59, 67, 72, | 1109 | 0 |
| | | | 74, 75, 76, 77, 78, 79, 80 | | |
| 110 | 0 | 21 | 40, 41, 49, 50, 51, 52, 54, 55, 59, 67, 70, 71, 72, 73, 74, 75, 76, | 1086 | 0 |
| | | | 77, 78, 79, 80 | | |
| 111 | 1 | 19 | 40, 51, 55, 56, 57, 62, 63, 65, 66, 69, 70, 71, 72, 73, 74, 75, 76, | 1034 | 123 |
| | | | 77, 78 | | |
| 112 | 0 | 19 | 46, 48, 49, 50, 51, 52, 67, 70, 71, 72, 74, 75, 76, 77, 78, 79, 80, | 1006 | 0 |
| | | | 81, 82 | | |
| 113 | 0 | 18 | 48, 49, 50, 51, 52, 54, 55, 67, 71, 72, 74, 75, 76, 77, 78, 79, 80, | 1071 | 0 |
| | | | 81 | | |
| 114 | 0 | 17 | 49, 50, 51, 52, 54, 55, 70, 71, 72, 73, 74, 75, 76, 77, 78, 79, 80 | 1007 | 0 |
| 115 | 3 | 19 | 55, 57, 60, 61, 62, 63, 65, 66, 69, 70, 71, 72, 73, 74, 75, 84, 85, | 1005 | 284 |
| | | | 91, 95 | | |
| 116 | 0 | 20 | 55, 63, 65, 66, 69, 70, 71, 72, 73, 74, 75, 76, 77, 78, 80, 82, 83, | 1036 | 0 |
| | | | 84, 85, 91 | | |
| 117 | 1 | 16 | 62, 65, 66, 69, 70, 71, 84, 85, 86, 87, 88, 89, 90, 91, 92, 95 | 1035 | 123 |
| 118 | 0 | 20 | 64, 66, 67, 68, 69, 70, 71, 72, 73, 74, 76, 78, 80, 81, 82, 83, 84, | 1067 | 0 |
| | | | 85, 91, 94 | | |
| 119 | 0 | 16 | 65, 66, 68, 69, 70, 71, 73, 74, 82, 83, 84, 85, 86, 87, 88, 91 | 1037 | 0 |
| 120 | 0 | 19 | 66, 67, 68, 69, 70, 71, 72, 73, 74, 75, 76, 78, 80, 82, 83, 84, 85, | 1056 | 0 |
| | | | 86, 91 | | |
| 121 | 0 | 17 | 66, 69, 70, 71, 72, 73, 74, 75, 76, 78, 80, 82, 83, 84, 85, 86, 91 | 1043 | 0 |
| 122 | 0 | 17 | 67, 68, 69, 70, 71, 72, 73, 74, 75, 76, 77, 78, 80, 81, 82, 83, 84 | 1004 | 0 |
| 123 | 0 | 17 | 67, 69, 70, 71, 72, 73, 74, 75, 76, 77, 78, 79, 80, 81, 82, 83, 84 | 1094 | 0 |
| 124 | 0 | 17 | 66, 67, 69, 70, 71, 72, 73, 74, 75, 76, 77, 78, 79, 80, 82, 83, 84 | 1011 | 0 |
| 125 | 0 | 13 | 66, 69, 70, 71, 72, 73, 80, 81, 82, 83, 84, 85, 86 | 1057 | 0 |

1. A method of determining a surface area of a molecule which comprises
a. taking a structural model of a molecule;
b. identifying and calculating the area of non-connected surface patches on each atom;
c. forming a primary graph having a vertex for each surface patch and an edge between vertices of intersecting surface patches;
d. forming a secondary graph having a vertex for each atom of the molecule and an edge between intersecting atoms;
e. splitting the primary graph into sets of components, each set corresponding to the surface patches on the atoms represented by a component of the secondary graph;
f. identifying the component representing the largest surface area in each set of components to form an atom level graph;
g. calculating the surface area by summing the surface areas represented by the atom level graph.

2. A method according to claim 1 which determines the surface area of more than one molecule wherein the structural model is of more than one molecule and the surface area is calculated by summing the surface areas represented by each component of the atom level graph.

3. A method according to claim 1 or 2 where the molecule is a polypeptide.

4. A method of calculating the surface area of a linear n-mer in a polypeptide which comprises:
a. identifying the atom level graph as described in claim 1;
b. forming an induced subgraph of the atom level graph with vertices corresponding to the surface patches of atoms in the epitope;
c. summing the surface areas represented by the component of the induced subgraph which represents the largest surface area.

5. A method of calculating the surface area of a linear n-mer in a polypeptide which comprises:
a. forming an atom level graph as described in claim 1;
b. splitting the atom level graph into induced subgraphs, each corresponding to a residue of the polypeptide;
c. for each component of the induced subgraphs, collapsing the corresponding vertices of the atom level graph to a single vertex to form a residue level graph;
d. forming an induced subgraph of the residue level graph with vertices corresponding to the surface patches of the residues in the epitope;
e. summing the surface areas represented by the component of the induced subgraph which represents the largest surface area.

6. A method of calculating the surface area of foreign atoms within a linear n-mer in a polypeptide which comprises:
a. forming an atom level graph as described in claim 1;
b. forming a residual atom graph for each component of the atom level graph by deleting vertices corresponding to the atoms of the epitope;
c. removing the component representing the largest surface area from each residual atom graph; and
d. summing the surface areas represented by the remaining vertices in the residual atom graphs.

7. A method of calculating the surface area of foreign residues within a linear n-mer of a polypeptide which comprises:
a. forming a residue level graph as described in claim 5;
b. forming a residual residue graph for each component of the residue level graph by deleting vertices corresponding to the residues of the epitope;
c. removing the component representing the largest surface area from each residual residue graph; and
d. summing the surface areas represented by the remaining vertices in the residual residue graphs.

8. A method of determining the compactness of a linear n-mer of a polypeptide which comprises dividing the surface area of that epitope, as defined in claim 4, with the square of the largest intra-atomic distance of atoms represented by the vertices of the component of the induced subgraph which represents the largest surface area as defined in claim 4.

9. A method of determining the compactness of a linear n-mer of a polypeptide which comprises dividing the surface area of that epitope, as defined in claim 5, with the square of the largest intra-atomic distance of atoms represented by the vertices of the component of the induced subgraph which represents the largest surface area as defined in claim 5.

10. A method of any previous claim where the surface area is the solvent accessible surface area.

11. A method of identifying a potentially immunogenic linear epitope of a polypeptide which comprises:
a. using a structural model of the polypeptide wherein the atoms have probe extended Van der Waals' radii, wherein the probe size is 1.4 Å;
b. determining the solvent accessible surface area by identifying the atom level graph as described in claim 1; forming an induced subgraph of the atom level graph with vertices corresponding to the surface patches of atoms in the epitope; summing the surface areas represented by the component of the induced subgraph which represents the largest surface area;
c. determining the solvent accessible surface area of foreign atoms or residues in the epitope by forming an atom level graph as described in claim 1; forming a residual atom graph for each component of the atom level graph by deleting vertices corresponding to the atoms of the epitope; removing the component representing the largest surface area from each residual atom graph; and summing the surface areas represented by the remaining vertices in the residual atom graphs;
d. determining the compactness of the epitope by dividing the surface area of that epitope, as defined in step b, with the square of the largest intra-atomic distance of atoms represented by the vertices of the component of the induced subgraph which represents the largest surface area;
e. identifying the epitope as potentially immunogenic if it has a solvent accessible surface area of at least 500 Å², a solvent accessible surface area of foreign atoms or residues below 10 Å² and a compactness of at least 0.55.

12. A method according to claim 10 wherein the epitope is identified as potentially immunogenic if it has a solvent accessible surface area of at least 1000 Å², has no foreign atoms or residues and has a compactness of at least 0.65.

13. A method according to claim 4 where the epitope contains from 8 to 36 residues.

14. A method according to claim 11 or 12 which is applied to the set of all overlapping n-mers in a polypeptide where n is from 8 to 36.

15. A method of identifying conformational epitopes which comprises:
a. taking each vertex in an atom or residue level graph as defined in claim 1, which is based on a structural model of a polypeptide, and adding to it the closest vertex in the graph;
b. repeating step a. by taking the next closest vertex to the original vertex, wherein the next closest vertex has an edge to the original vertex, or to any vertices added to it, until the combined solvent accessible surface area of the vertices reaches a pre-defined area.

16. A method according to claim 14 wherein, in the structural model of the polypeptide, the atoms have probe extended Van der Waals' radii, wherein the probe size is 1.4 Å, the predefined solvent accessible surface area is 1000 Å² when using the residue level graph or 900 Å² when using the atom level graph.

17. A method according to any preceding claim carried out on a computer.

18. A computer programmed to implement a method of claim 1.

19. A computer readable medium comprising a program capable of implementing a method of claim 1.

20. A method according to claim 1 wherein the area of non-connected surface patches is calculated by:
a. assigning each atom a radius;
b. representing each atom as an octahedron or icosahedron where each face is a spherical triangle;
c. eliminating any spherical triangle on each atom falling completely within the radius of another atom;
d. splitting any spherical triangle falling partially within the radius of another atom into two spherical triangles and eliminating either of these two spherical triangles falling completely within the radius of the other atom;
e. repeating step d until no spherical triangles above a predefined area fall partially within the radius of another atom.
